(19) United States
(12) Patent Application Publication
(10) Pub. No.: US 2012/0169789 A1
(43) Pub. Date: Jul. 5, 2012

(54) METHOD FOR DRIVING PLASMA DISPLAY PANEL AND PLASMA DISPLAY DEVICE

(76) Inventors: Takahiko Origuchi, Osaka (JP); Kazuhiro Yamada, Osaka (JP)

(21) Appl. No.: 13/394,314

(22) PCT Filed: Sep. 9, 2010
(86) PCT No.: PCT/JP2010/005514

§ 371 Date: Mar. 5, 2012

(30) Foreign Application Priority Data
Sep. 11, 2009 (JP) 2009-210064
Sep. 11, 2009 (JP) 2009-210065

(51) Int. Cl. G09G 3/28; G09G 5/10

(52) U.S. Cl. 345/690; 345/63

(57) ABSTRACT

The image display quality is improved by reducing the afterimage phenomenon of a display image on a plasma display panel. For this purpose, the image display region of the panel is divided into a plurality of regions, the difference between the luminance gradation value in the present field and that in the field immediately before the present field is calculated as the inter-field luminance difference. Then, the number of pixels where the inter-field luminance difference is lower than a predetermined luminance comparison value is counted, and the counting result is set as a first count value. The number of edges where the difference between the luminance gradation values of adjacent pixels is equal to a predetermined edge comparison value or larger is counted, and the counting result is set as a second count value. The afterimage strength level region is calculated based on the first and second count values.

### TECHNICAL FIELD

The present application relates to a driving method of a plasma display panel and a plasma display apparatus that are used in a television or a large monitor.

### BACKGROUND ART

An alternating-current surface discharge type panel such as a plasma display panel (hereinafter referred to as “panel”) has many discharge cells between a front plate and a rear plate that are faced to each other. The front plate has the following elements:
a plurality of display electrode pairs disposed in parallel on a front glass substrate; and
a dielectric layer and a protective layer for covering the display electrode pairs.
   Here, each display electrode pair is formed of a pair of scan electrode and sustain electrode. The rear plate has the following elements:
a plurality of data electrodes disposed in parallel on a rear glass substrate;
a dielectric layer for covering the data electrodes;
a plurality of barrier ribs disposed on the dielectric layer in parallel with the data electrodes; and
phosphor layers disposed on the surface of the dielectric layer and on the side surfaces of the barrier ribs.

The front plate and rear plate are faced to each other so that the display electrode pairs and the data electrodes three-dimensionally intersect, and are sealed. Discharge gas containing xenon with a partial pressure of 5%, for example, is filled into a discharge space in the sealed product. Discharge cells are disposed in intersecting parts of the display electrode pairs and the data electrodes. In the panel having this structure, ultraviolet rays are emitted by gas discharge in each discharge cell. The ultraviolet rays excite respective phosphors of red (R), green (G), and blue (B) to emit light, and thus provide color display.

A subfield method is generally used as a method of driving the panel. In this subfield method, one field is divided into a plurality of subfields, and light is emitted or light is not emitted in each discharge cell in each subfield, thereby performing gradation display. Each subfield has an initializing period, an address period, and a sustain period.

In the initializing period, an initializing waveform is applied to each scan electrode, and initializing discharge is caused in each discharge cell. Thus, wall charge required for a subsequent address operation is formed in each discharge cell, and a priming particle (an excitation particle for causing address discharge) for stably causing address discharge is generated.

In the address period, a scan pulse is applied to scan electrodes, and an address pulse is applied to data electrodes based on an image signal to be displayed. Thus, address discharge is caused in a discharge cell to emit light, thereby producing wall charge (hereinafter, this operation is also referred to as “address”).

In a sustain period, as many sustain pulses as a number determined for each subfield are alternately applied to the display electrode pairs formed of the scan electrodes and the sustain electrodes. Thus, sustain discharge is caused in the discharge cell having undergone address discharge, thereby emitting light in the phosphor layer of this discharge cell. Thus, light is emitted at a luminance corresponding to the luminance weight determined for each subfield. Thus, light is emitted at a luminance corresponding to the gradation value of an image signal in each discharge cell of the panel, and an image is displayed in the image display region.

As one of subfield methods, the following driving method has been studied, for example. In this driving method, light emission that is not related to the gradation display can be minimized, and the contrast ratio of the display image can be improved. In other words, in the initializing period of one of a plurality of subfields, an all-cell initializing operation of causing initializing discharge in all discharge cells is performed. In the initializing periods of other subfields, a selective initializing operation of causing initializing discharge only in the discharge cell that has undergone sustain discharge in the immediately preceding sustain period is performed. The luminance (hereinafter, referred to as “luminance of black level”) in a black display region that does not cause sustain discharge is therefore determined only by weak light emission in the all-cell initializing operation. As a result, image display of high contrast ratio is allowed (for example, Patent Literature 1).

As the definition of the panel has been enhanced and the screen of the panel has been enlarged, recently, various methods for improving the luminous efficiency of the panel and luminance have been studied. For example, a method for improving the luminous efficiency by increasing the xenon partial pressure of the discharge gas to be filled into the discharge cell has been studied. When the xenon partial pressure of the discharge gas is increased, however, variation in timing of causing discharge can increase and emission intensity for each discharge cell can vary to make the display luminance non-uniform. In order to reduce the luminance non-uniformity, a driving method is disclosed where, in a sustain period, a steeply rising sustain pulse is generated a plurality of times to align the timing of sustain discharge, and the display luminance is uniformed (for example, Patent Literature 2).

A technology of improving the display quality by suppressing variation in emission intensity for each discharge cell, by setting the switching timing from a power recovery circuit to a clamping circuit of sustain pulses that belong to a first group including the firstly applied sustain pulse to be later than that of sustain pulses that belong to the other groups in the sustain period (for example, Patent Literature 3).

When the xenon partial pressure of the discharge gas is increased in order to increase the luminous efficiency, however, a static image is recognized as an afterimage when the static image is displayed for a long time, namely an afterimage phenomenon is apt to occur and the image display quality can be damaged.

### CITATION LIST

### Patent Literature

PLT 1 Unexamined Japanese Patent Publication No. 2000-242224
PLT 2 Unexamined Japanese Patent Publication No. 2005-338120
PLT 3 Unexamined Japanese Patent Publication No. 2006-146035

### SUMMARY OF THE INVENTION

A driving method of a panel of the present invention is a driving method of a panel that has a plurality of discharge cells each of which includes a data electrode and a display electrode pair formed of a scan electrode and a sustain electrode. Each pixel includes a plurality of discharge cells. In this driving method, the panel is driven to perform gradation display while one field includes a plurality of subfields each of which has an address period and sustain period. In the sustain period, sustain pulses in a quantity calculated by multiplying the luminance weight set for each subfield by luminance magnification are generated. This driving method includes the following steps:
dividing the image display region of the panel into a plurality of regions;
calculating the afterimage strength level for each region based on the luminance gradation value set for each pixel in response to an image signal;
calculating, as the inter-field luminance difference, a difference between the luminance gradation value in the present field and that in the field immediately before the present field for each pixel, counting a number of pixels where the inter-field luminance difference is smaller than a predetermined luminance comparison value of each region, and setting the counting result of counting the number of pixels as a first count value in each region;
counting, for each region, a number of edges where the difference between the luminance gradation values of adjacent pixels is not smaller than a predetermined edge comparison value and setting the counting result as a second count value in each region; and
calculating the afterimage strength level of each region based on the first count value and second count value.

Thus, the afterimage strength level as a guideline of the occurrence of an afterimage phenomenon can be calculated based on the luminance gradation value, so that it can be determined based on the afterimage strength level whether the afterimage phenomenon is apt to occur.

In a driving method of a panel of the present invention, the afterimage strength level of each region may be updated in the following processes. In regions where the first count value is equal to a first threshold or larger and the second count value is equal to a third threshold or larger, a first set value is added to the afterimage strength level of each region. In regions where the first count value is smaller than the first threshold and is not smaller than a second threshold, which is smaller than the first threshold, and the second count value is equal to the third threshold or larger, a second set value is added to the afterimage strength level for each region. In regions where the first count value is smaller than the second threshold and the second count value is equal to the third threshold or larger, a third set value is added to the afterimage strength level of each region. In regions where the second count value is smaller than the third threshold, a fourth set value is added to the afterimage strength level of each region. Thus, in the regions where the first count value is equal to the first threshold or larger and the second count value is equal to the third threshold or larger, the first set value is cumulatively added to the afterimage strength level of each region. In the regions where the first count value is smaller than the first threshold and is not smaller than the second threshold, which is smaller than the first threshold, and the second count value is equal to the third threshold or larger, the second set value is cumulatively added to the afterimage strength level of each region. In the regions where the first count value is smaller than the second threshold and the second count value is equal to the third threshold or larger, the third set value is cumulatively added to the afterimage strength level of each region. In the regions where the second count value is smaller than the third threshold, the fourth set value is cumulatively added to the afterimage strength level of each region. Therefore, the afterimage strength level of each region can be updated in each field in response to the feature of the image in each region.

In a driving method of a panel of the present invention, the first set value may be a positive numerical value, the second set value may be 0, and the third set value and fourth set value may be negative numerical values. Thus, in the regions where the first count value is equal to the first threshold or larger and the second count value is equal to the third threshold or larger, the possibility of causing the afterimage phenomenon is assumed to be high, and the first set value is set at a positive value to increase the afterimage strength level. In the regions where the first count value is smaller than the second threshold and the second count value is equal to the third threshold or larger, and in the regions where the second count value is smaller than the third threshold, the possibility of causing the afterimage phenomenon is assumed to be low, and the third set value and fourth set value are set to be negative values to decrease the afterimage strength level. In the regions where the first count value is smaller than the first threshold and is not smaller than the second threshold and the second count value is equal to the third threshold or larger, the possibility of causing he afterimage phenomenon is assumed to be kept constant, and the second set value is set at 0 to keep the afterimage strength level constant.

In a driving method of a panel of the present invention, a predetermined constant may be subtracted from the afterimage strength level after the update. Thus, the control start timing based on the afterimage strength level can be controlled. The control start timing is, for example, timing of starting the correction of the luminance gradation value described later, or timing of starting change of the generation ratio between a first sustain pulse and a second sustain pulse described later.

In a driving method of a panel of the present invention, the afterimage strength level after the update may be restricted not to exceed a predetermined upper limit. Thus, excessive correction can be prevented from occurring when the control described later is performed based on the afterimage strength level.

In a driving method of a panel of the present invention, the following processes may be employed. In each region, the afterimage strength level of each region is assumed as the afterimage strength level of the center pixel positioned in the center of the region. The afterimage strength level of each of the pixels other than the center pixel is calculated, based on the afterimage strength level of the center pixel and the distances between the pixel whose afterimage strength level is to be calculated and a plurality of center pixels around the pixel. The luminance gradation value of each pixel is changed based on the afterimage strength level of each pixel. Thus, the afterimage strength level of each pixel can be calculated based on the afterimage strength level of each region. By changing the luminance gradation value of each pixel based on the calculated afterimage strength level, the afterimage phenomenon of a display image on the panel can be reduced and the image display quality can be improved.

In a driving method of a panel of the present invention, the following processes may be employed. The afterimage strength level of each pixel is subtracted from a predetermined reference value, the luminance gradation value of each pixel is multiplied by the result obtained by dividing the subtraction result by the reference value, thereby changing the luminance gradation value of each pixel. Thus, the correction of the luminance gradation value based on the afterimage strength level can be performed appropriately.

In a driving method of a panel of the present invention, the following processes may be employed. The luminance gradation value is changed based on the afterimage strength level only in the pixel where the luminance gradation value of each pixel is equal to a predetermined high-luminance threshold or higher. Thus, the plasma display apparatus can be operated so that the luminance gradation value is corrected in response to the magnitude of the afterimage strength level only in the pixel where the luminance gradation value is high and the luminance difference between the pixel and its adjacent pixel is large.

In a driving method of a panel of the present invention, the following processes may be employed. The average picture level of an image signal is detected, and the afterimage strength level of each pixel is changed based on the average picture level so that the afterimage strength level is lower when the average picture level is high than when the average picture level is low. Thus, the afterimage strength level as a guideline of the occurrence of an afterimage phenomenon can be changed based on the detected average picture level, and the luminance gradation value of each pixel can be changed based on the afterimage strength level after the change. Therefore, in an image of high average picture level where the afterimage phenomenon is considered to occur relatively hardly, the magnitude of the afterimage strength level can be made lower than in an image of low average picture level. For example, the occurrence of the afterimage phenomenon can be reduced while the luminance reduction of the display image is prevented in the image of high average picture level.

In a driving method of a panel of the present invention, the following processes may be employed. The afterimage strength level of each pixel is changed based on luminance magnification so that the afterimage strength level is lower when the luminance magnification is low than when the luminance magnification is high. Thus, the afterimage strength level as a guideline of the occurrence of the afterimage phenomenon can be changed based on the luminance magnification, and the luminance gradation value of each pixel can be changed based on the afterimage strength level after the change. Therefore, when the luminance magnification is low and the afterimage phenomenon is considered to occur relatively hardly, the magnitude of the afterimage strength level can be lower than that when the luminance magnification is high. As a result, the occurrence of the afterimage phenomenon can be reduced while the luminance reduction of the image displayed when the luminance magnification is low is prevented, for example.

In a driving method of a panel of the present invention, the following processes may be employed. The luminance gradation value of each pixel is smoothed based on the afterimage strength level of each pixel so that the luminance gradation value is smoother when the afterimage strength level is high than when the afterimage strength level is low. Thus, the luminance difference between adjacent pixels can be reduced and the occurrence of the afterimage phenomenon can be further reduced.

In a driving method of a panel of the present invention, the following processes may be employed. The chroma set for each pixel based on the image signal is changed based on the afterimage strength level of each pixel, and the chroma is lower when the afterimage strength level is high than when the afterimage strength level is low. In an image of high chroma, namely in an image of a dark color, the difference in gradation value of each discharge cell of RGB constituting one pixel is apt to become larger than in an image of low chroma and a bright color. Therefore, by reducing the chroma in response to the magnitude of the afterimage strength level, the difference in gradation value of each discharge cell of RGB can be reduced and the occurrence of the afterimage phenomenon can be further reduced.

In a driving method of a panel of the present invention, the following processes may be employed. The regions are set by disposing a plurality of boundaries in the extension direction of the display electrode pairs and by disposing a plurality of boundaries in the extension direction of the data electrodes so that the number of pixels of each region can be equal to each other.

In a driving method of a panel of the present invention, the following processes may be employed. In the sustain period, a first sustain pulse and a second sustain pulse rising more steeply than the first sustain pulse are generated, and the generation ratio between the first sustain pulse and the second sustain pulse is changed based on the afterimage strength level. Thus, the generation ratio between the first sustain pulse as the reference and the second sustain pulse can be changed based on the calculated afterimage strength level. Here, the second sustain pulse has a steeper gradient than that of the first sustain pulse and has a high suppressing effect of the afterimage phenomenon. Therefore, the sustain discharge can be stably generated while the power consumption is reduced, the afterimage phenomenon of the display image on the panel can be reduced, and the image display quality can be improved.

In a driving method of a panel of the present invention, the following processes may be employed. The maximum value of the afterimage strength level of each region is detected. The generation ratio of the second sustain pulse is gradually increased after the maximum value of the afterimage strength level becomes a first afterimage strength level threshold or higher. The generation ratio of the second sustain pulse is gradually decreased after a lapse of a predetermined period after the maximum value of the afterimage strength level becomes a second afterimage strength level threshold or lower. Here, the second afterimage strength level threshold is lower than the first afterimage strength level threshold. Thus, the generation ratio between the first sustain pulse and the second sustain pulse can be changed in response to the maximum value of the afterimage strength level in each region.

In a driving method of a panel of the present invention, the following processes may be employed. The period after the maximum value of the afterimage strength level becomes the first afterimage strength level threshold or higher until it becomes the second afterimage strength level threshold or lower is assumed to be a first period, the predetermined period is assumed to be a second period, and the second period is changed according to the first period within a range of a predetermined upper limit period or shorter. Thus, in the second period after the maximum value of the afterimage strength level becomes the second afterimage strength level threshold or lower, the state where the generation ratio of the second sustain pulse is increased can be kept.

In a driving method of a panel of the present invention, the second period may be set to be one-third of the first period.

In a driving method of a panel of the present invention, the following processes may be employed. The average value of the afterimage strength level in each region is calculated. The generation ratio of the second sustain pulse is gradually increased after the average value of the afterimage strength level becomes the first afterimage strength level threshold or higher. The generation ratio of the second sustain pulse is gradually decreased after a lapse of a predetermined period after the average value of the afterimage strength level becomes the second afterimage strength level threshold or lower. Here, the second afterimage strength level threshold is lower than the first afterimage strength level threshold. Thus, the generation ratio between the first sustain pulse and the second sustain pulse can be changed in response to the average value of the afterimage strength level of each region.

The plasma display apparatus of the present invention has the following elements:
a panel that has a plurality of discharge cells each of which includes a display electrode pair formed of a scan electrode and a sustain electrode and where one pixel is constituted by the plurality of discharge cells, one field includes a plurality of subfields having an address period and a sustain period, and gradation display is performed; and
an image signal processing circuit for setting a luminance gradation value for each pixel based on an image signal and generating image data indicating light emission and no light emission in each subfield in each discharge cell based on the image signal.
   The image signal processing circuit divides the display region of the panel into a plurality of regions, and calculates afterimage strength level of each region based on the luminance gradation value set for each pixel in response to the image signal.

Thus, the afterimage strength level as a guideline of the occurrence of an afterimage phenomenon can be calculated based on the luminance gradation value, so that it can be determined based on the afterimage strength level whether an image to be displayed on the panel is apt to cause an afterimage phenomenon.

In the plasma display apparatus of the present invention, the image signal processing circuit may have a configuration for calculating afterimage strength level of each pixel based on the afterimage strength level of each region and for changing the luminance gradation value of each pixel based on the afterimage strength level of each pixel. Since the afterimage strength level of each pixel can be calculated based on the afterimage strength level of each region and the luminance gradation value of each pixel is changed based on the calculated afterimage strength level, the afterimage phenomenon of the display image on the panel can be reduced, and the image display quality can be improved.

The plasma display apparatus of the present invention has the following elements:
a power recovery circuit for raising or decreasing a sustain pulse by resonating an inductor and an inter-electrode capacity of the display electrode pairs;
a clamping circuit for clamping the voltage of the sustain pulse on a predetermined voltage; and
a sustain pulse generation circuit for alternately applying, to the display electrode pairs, sustain pulses in a quantity corresponding to the luminance weight set for each subfield in the sustain period.
   The sustain pulse generation circuit may have a configuration for generating a first sustain pulse and a second sustain pulse, which rises more steeply than the first sustain pulse, and for changing the generation ratio between the first sustain pulse and second sustain pulse based on the afterimage strength level. Thus, based on the calculated afterimage strength level, the generation ratio between the first sustain pulse as the reference and the second sustain pulse, which has a steeper rising gradient than that of the first sustain pulse and a high suppressing effect of the afterimage phenomenon, can be changed. Therefore, the sustain discharge can be stably generated while the power consumption is reduced, the afterimage phenomenon of the display image on the panel can be reduced, and the image display quality can be improved.

In the plasma display apparatus of the present invention, the image signal processing circuit may include the following configuration. The image signal processing circuit has the following elements:
an afterimage strength level maximum value detecting circuit for detecting the maximum value of the afterimage strength level of each region; and
a comparing circuit for comparing the maximum value of the afterimage strength level with a first afterimage strength level threshold and a second afterimage strength level threshold, which is lower than the first afterimage strength level threshold.
   The sustain pulse generation circuit gradually increases the generation ratio of the second sustain pulse after the maximum value of the afterimage strength level becomes the first afterimage strength level threshold or higher. The sustain pulse generation circuit gradually decreases the generation ratio of the second sustain pulse after a lapse of a predetermined period after the maximum value of the afterimage strength level becomes the second afterimage strength level threshold or lower. Thus, the generation ratio between the first sustain pulse and the second sustain pulse can be changed in response to the maximum value of the afterimage strength level of each region.

In the plasma display apparatus of the present invention, the image signal processing circuit may have the following configuration. The image signal processing circuit includes the following elements:
an afterimage strength level average value calculating circuit for calculating the average value of the afterimage strength level of each region; and
a comparing circuit for comparing the average value of the afterimage strength level with a first afterimage strength level threshold and with a second afterimage strength level threshold lower than the first afterimage strength level threshold.
   The sustain pulse generation circuit gradually increases the generation ratio of the second sustain pulse after the average value of the afterimage strength level becomes the first afterimage strength level threshold or higher. The sustain pulse generation circuit gradually decreases the generation ratio of the second sustain pulse after a lapse of a predetermined period after the average value of the afterimage strength level becomes the second afterimage strength level threshold or lower. Thus, the generation ratio between the first sustain pulse and the second sustain pulse can be changed in response to the average value of the afterimage strength level in each region.

### BRIEF DESCRIPTION OF DRAWINGS

FIG. 1 is an exploded perspective view showing a structure of a panel used in accordance with a first exemplary embodiment of the present invention.

FIG. 2 is an electrode array diagram of the panel used in accordance with the first exemplary embodiment of the present invention.

FIG. 3 is a waveform chart of driving voltage to be applied to each electrode of the panel in accordance with the first exemplary embodiment of the present invention.

FIG. 4 is a circuit block diagram of a plasma display apparatus in accordance with the first exemplary embodiment of the present invention.

FIG. 5 is a diagram for schematically showing one example of a plurality of regions disposed in the image display region of the panel in accordance with the first exemplary embodiment of the present invention.

FIG. 6 is a circuit block diagram showing one configuration example of an image signal processing circuit in accordance with the first exemplary embodiment of the present invention.

FIG. 7 is a circuit block diagram showing one configuration example of an afterimage strength level calculating circuit in accordance with the first exemplary embodiment of the present invention.

FIG. 8 is a diagram for schematically showing an operation by an afterimage strength level interpolating circuit in accordance with the first exemplary embodiment of the present invention.

FIG. 9 is a circuit block diagram showing one configuration example of a correcting circuit in accordance with the first exemplary embodiment of the present invention.

FIG. 10 is a circuit block diagram showing one configuration example of a correcting circuit in accordance with a second exemplary embodiment of the present invention.

FIG. 11 is a circuit block diagram showing one configuration example of a correcting circuit in accordance with a third exemplary embodiment of the present invention.

FIG. 12 is a circuit block diagram showing one configuration example of a correcting circuit in accordance with a fourth exemplary embodiment of the present invention.

FIG. 13 is a circuit block diagram showing one configuration example of a correcting circuit in accordance with a fifth exemplary embodiment of the present invention.

FIG. 14 is a circuit block diagram showing one configuration example of a correcting circuit in accordance with a sixth exemplary embodiment of the present invention.

FIG. 15 is a circuit block diagram of a plasma display apparatus in accordance with a seventh exemplary embodiment of the present invention.

FIG. 16 is a circuit block diagram showing one configuration example of an image signal processing circuit in accordance with the seventh exemplary embodiment of the present invention.

FIG. 17 is a circuit diagram of a sustain pulse generation circuit in accordance with the seventh exemplary embodiment of the present invention.

FIG. 18 is a timing chart for illustrating an operation of the sustain pulse generation circuit.

FIG. 19 is a schematic waveform chart for comparatively showing two types of sustain pulses in accordance with the seventh exemplary embodiment of the present invention.

FIG. 20 is a characteristic diagram showing the relationship between “rising period” of the sustain pulses and variation in discharge in accordance with the seventh exemplary embodiment of the present invention.

FIG. 21 is another characteristic diagram showing the relationship between “rising period” of the sustain pulses and variation in discharge in accordance with the seventh exemplary embodiment of the present invention.

FIG. 22 is a characteristic diagram showing the relationship between “rising period” of the sustain pulses and luminous efficiency in accordance with the seventh exemplary embodiment of the present invention.

FIG. 23 is a characteristic diagram showing the relationship between “rising period” of the sustain pulses and reactive power in accordance with the seventh exemplary embodiment of the present invention.

FIG. 24 is a schematic diagram showing one example of time variation in maximum value of afterimage strength level in accordance with the seventh exemplary embodiment of the present invention.

FIG. 25 is a schematic diagram showing one example of change of the generation ratio of the second sustain pulse in accordance with the seventh exemplary embodiment of the present invention.

FIG. 26 is a schematic diagram showing another example of change of the generation ratio of the second sustain pulse in accordance with the seventh exemplary embodiment of the present invention.

FIG. 27 is a schematic diagram showing another example of time variation in maximum value of afterimage strength level in accordance with the seventh exemplary embodiment of the present invention.

FIG. 28 is a schematic diagram showing yet another example of change of the generation ratio of the second sustain pulse in accordance with the seventh exemplary embodiment of the present invention.

FIG. 29 is a schematic waveform chart showing one example of generation of the first sustain pulse and the second sustain pulse when the generation ratio of the second sustain pulse is 20% in accordance with the seventh exemplary embodiment of the present invention.

FIG. 30 is a schematic waveform chart showing one example of generation of the first sustain pulse and the second sustain pulse when the generation ratio of the second sustain pulse is 40% in accordance with the seventh exemplary embodiment of the present invention.

FIG. 31 is a circuit block diagram showing one configuration example of an image signal processing circuit in accordance with an eighth exemplary embodiment of the present invention.

### DESCRIPTION OF EMBODIMENTS

A plasma display apparatus in accordance with an exemplary embodiments of the present invention will be described hereinafter with reference to the accompanying drawings.

### First Exemplary Embodiment

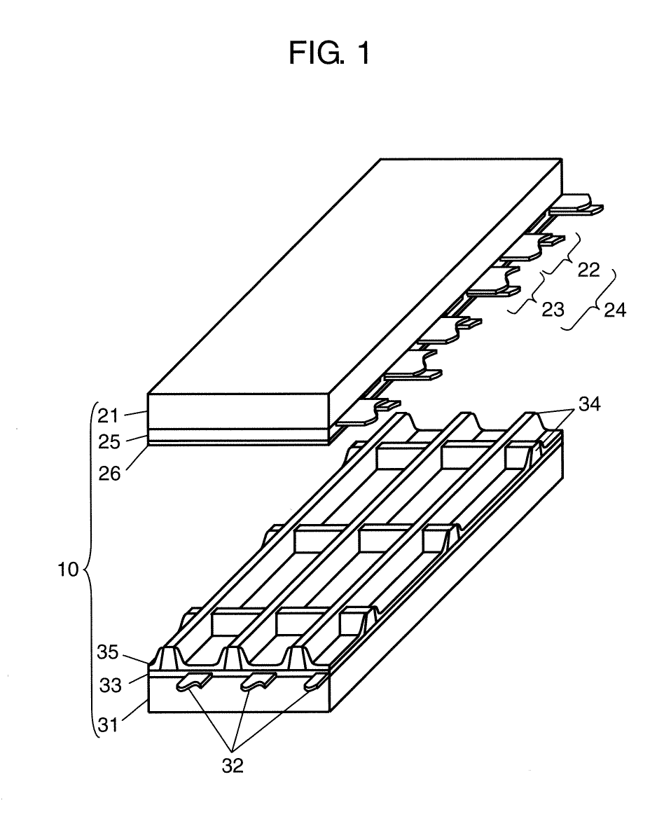

FIG. 1 is an exploded perspective view showing the structure of panel 10 used in a plasma display apparatus in accordance with a first exemplary embodiment of the present invention. A plurality of display electrode pairs 24 formed of scan electrodes 22 and sustain electrodes 23 is disposed on glass-made front plate 21. Dielectric layer 25 is formed so as to cover scan electrodes 22 and sustain electrodes 23, and protective layer 26 is formed on dielectric layer 25. Protective layer 26 is made of a material mainly made of magnesium oxide (MgO).

A plurality of data electrodes 32 is formed on rear plate 31, dielectric layer 33 is formed so as to cover data electrodes 32, and mesh barrier ribs 34 are formed on dielectric layer 33. Phosphor layers 35 for emitting lights of respective colors of red (R), green (G), and blue (B) are formed on the side surfaces of barrier ribs 34 and on dielectric layer 33.

Front plate 21 and rear plate 31 face to each other so that display electrode pairs 24 cross data electrodes 32 with a micro discharge space sandwiched between them, and the outer peripheries of them are sealed by a sealing material such as glass frit. The discharge space is filled with mixed gas of neon and xenon as discharge gas, for example. In the present embodiment, discharge gas where xenon partial pressure is set at about 10% is employed for improving the luminous efficiency. The discharge space is partitioned into a plurality of sections by barrier ribs 34. Discharge cells are formed in the intersecting parts of display electrode pairs 24 and data electrodes 32. The discharge cells discharge and emit light to display an image on panel 10.

In panel 10, one pixel is formed of three consecutive discharge cells arranged in the extending direction of display electrode pairs 24. In other words, the three discharge cells are a discharge cell for emitting light of red color (R), a discharge cell for emitting light of green color (G), and a discharge cell for emitting light of blue color (B).

The structure of panel 10 is not limited to the above-mentioned one, but may have striped barrier ribs, for example. The mixing ratio of the discharge gas is not limited to the above-mentioned numerical value, but may be another mixing ratio.

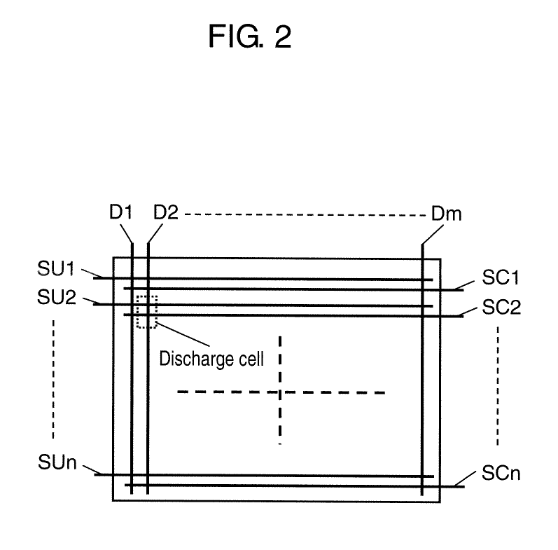

FIG. 2 is an electrode array diagram of panel 10 in accordance with the first exemplary embodiment of the present invention. Panel 10 has n scan electrode SC1 through scan electrode SCn (scan electrodes 22 in FIG. 1) and n sustain electrode SU1 through sustain electrode SUn (sustain electrodes 23 in FIG. 1) both extended in the row direction, and m data electrode D1 through data electrode Dm (data electrodes 32 in FIG. 1) extended in the column direction. A discharge cell is formed in the part where a pair of scan electrode SCi (i is 1 through n) and sustain electrode SUi intersect with one data electrode Dk (k is 1 through m). Thus, m×n discharge cells are formed in the discharge space. The region having m×n discharge cells defines the image display region of panel 10. In the panel where the number of pixels is 1920×1080, for example, m is 1920×3 and n is 1080.

Next, a driving voltage waveform and its operation for driving panel 10 are described schematically. The plasma display apparatus of the present embodiment performs gradation display by a subfield method. In this subfield method, the plasma display apparatus divides one field into a plurality of subfields on the time axis, and sets luminance weight for each subfield. Then, the plasma display apparatus controls light emission and no light emission of each discharge cell in each subfield.

In the present exemplary embodiment, for example, one field is formed of 8 subfields (first SF, second SF, . . . , eighth SF), and respective subfields have luminance weights of (1, 2, 4, 8, 16, 32, 64, 128) in ascending order where the luminance weight is larger in a later subfield. In the initializing period of one subfield, of a plurality of subfields, an all-cell initializing operation of causing the initializing discharge in all discharge cells is performed. In the initializing period of the other subfields, a selective initializing operation of selectively causing the initializing discharge in the discharge cell that has undergone sustain discharge in the immediately preceding sustain period is performed. Thus, light emission in a black region causing no sustain discharge can be minimized, and the contrast ratio of an image to be displayed on panel 10 can be increased. Hereinafter, a subfield where the all-cell initializing operation is performed is referred to as “all-cell initializing subfield”, and a subfield where the selective initializing operation is performed is referred to as “selective initializing subfield”.

In the present embodiment, the all-cell initializing operation is performed in the initializing period of the first SF, and the selective initializing operation is performed in the initializing periods of the second SF through eighth SF. Thus, light emission related to no image display is only light emission following the discharge of the all-cell initializing operation in the first SF. The luminance of black level, which is luminance in a black display region causing no sustain discharge, is therefore determined only by weak light emission in the all-cell initializing operation. This allows image display of sharp contrast on panel 10. In a sustain period of each subfield, sustain pulses in a quantity calculated by multiplying the luminance weight of each subfield by a predetermined proportionality constant are applied to each display electrode pair 24. The proportionality constant is luminance magnification.

In the present embodiment, the number of subfields and the luminance weight of each subfield are not limited to the above-mentioned values. The subfield structure may be changed based on an image signal or the like.

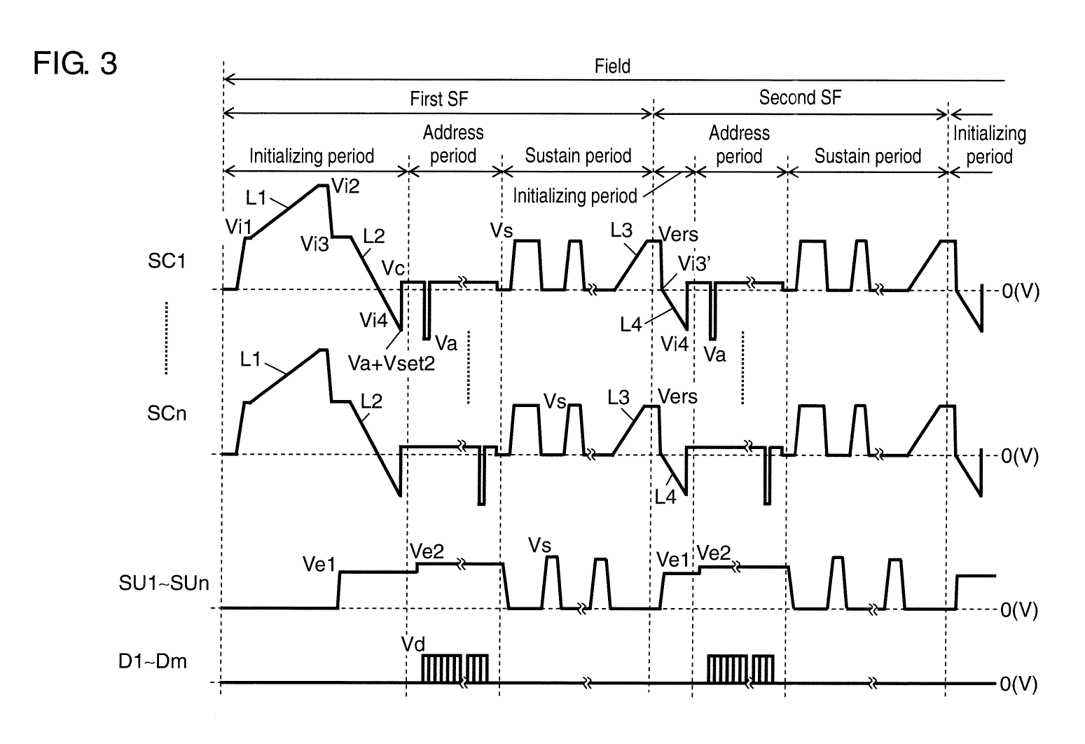

FIG. 3 is a waveform chart of driving voltage applied to each electrode of panel 10 in accordance with the first exemplary embodiment of the present invention. FIG. 3 shows driving voltage waveforms of scan electrode SC1 for firstly performing an address operation in the address period, scan electrode SCn (e.g. scan electrode SC1080) for finally performing the address operation in the address period, sustain electrode SU1 through sustain electrode SUn, and data electrode D1 through data electrode Dm.

FIG. 3 shows driving voltage waveforms of two subfields. These two subfields are a first subfield (first SF) which is an all-cell initializing subfield, and a second subfield (second SF) which is a selective initializing subfield. The driving voltage waveforms in other subfields are substantially similar to the driving voltage waveform in the second SF except for the number of generated sustain pulses in the sustain period. Each of scan electrode SCi, sustain electrode SUi, and data electrode Dk discussed later means an electrode that is selected from each kind of electrodes based on image data (which indicates light emission or no light emission in each subfield).

First, a first SF as the all-cell initializing subfield is described.

In the first half of the initializing period of the first SF, 0 (V) is applied to data electrode D1 through data electrode Dm and sustain electrode SU1 through sustain electrode SUn. Voltage Vi1 is applied to scan electrode SC1 through scan electrode SCn. Voltage Vi1 is set to be lower than a discharge start voltage with respect to sustain electrode SU1 through sustain electrode SUn. Ramp voltage, which gently increases from voltage Vi1 to voltage V12, is applied to scan electrode SC1 through scan electrode SCn. This ramp voltage is hereinafter referred to as “up-ramp voltage L1”. Voltage V12 is set to exceed the discharge start voltage with respect to sustain electrode SU1 through sustain electrode SUn. One example of the gradient of up-ramp voltage L1 is a numerical value of about 1.3 V/μsec.

While up-ramp voltage L1 increases, feeble initializing discharge continuously occurs between scan electrode SC1 through scan electrode SCn and sustain electrode SU1 through sustain electrode SUn, and feeble initializing discharge continuously occurs between scan electrode SC1 through scan electrode SCn and data electrode D1 through data electrode Dm. Negative wall voltage is accumulated on scan electrode SC1 through scan electrode SCn, and positive wall voltage is accumulated on data electrode D1 through data electrode Dm and sustain electrode SU1 through sustain electrode SUn. The wall voltage on the electrodes means voltage generated by the wall charge accumulated on the dielectric layer for covering the electrodes, the protective layer, or the phosphor layers.

In the latter half of the initializing period, positive voltage Ve1 is applied to sustain electrode SU1 through sustain electrode SUn, and 0 (V) is applied to data electrode D1 through data electrode Dm. Ramp voltage, which gently decreases from voltage V13 to negative voltage V14, is applied to scan electrode SC1 through scan electrode SCn. This ramp voltage is hereinafter referred to as “down-ramp voltage L2”. Voltage V13 is set to be lower than the discharge start voltage with respect to sustain electrode SU1 through sustain electrode SUn, and voltage V14 is set to exceed the discharge start voltage. One example of the gradient of down-ramp voltage L2 is a numerical value of about −2.5 V/μsec.

While down-ramp voltage L2 is applied to scan electrode SC1 through scan electrode SCn, feeble initializing discharge occurs between scan electrode SC1 through scan electrode SCn and sustain electrode SU1 through sustain electrode SUn, and feeble initializing discharge occurs between scan electrode SC1 through scan electrode SCn and data electrode D1 through data electrode Dm. The negative wall voltage on scan electrode SC1 through scan electrode SCn and the positive wall voltage on sustain electrode SU1 through sustain electrode SUn are reduced. The positive wall voltage on data electrode D1 through data electrode Dm is adjusted to a value appropriate for the address operation. Thus, the all-cell initializing operation of causing initializing discharge in all discharge cells is completed.

In the subsequent address period, scan pulse voltage Va is sequentially applied to scan electrode SC1 through scan electrode SCn. Positive address pulse voltage Vd is applied to data electrode Dk (k is 1 through m) corresponding to the discharge cell to emit light, of data electrode D1 through data electrode Dm. Thus, address discharge is selectively caused in each discharge cell.

Specifically, voltage Ve2 is firstly applied to sustain electrode SU1 through sustain electrode SUn, and voltage Vc (voltage Va+voltage Vsc) is applied to scan electrode SC1 through scan electrode SCn.

Then, negative scan pulse voltage Va is applied to scan electrode SC1 in the first row, positive address pulse voltage Vd is applied to data electrode Dk (k is 1 through m) in the discharge cell to emit light in the first row, of data electrode D1 through data electrode Dm. At this time, the voltage difference in the intersecting part of data electrode Dk and scan electrode SC1 is derived by adding the difference between the wall voltage on data electrode Dk and that on scan electrode SC1 to the difference (voltage Vd−voltage Va) of the external applied voltage. Thus, the voltage difference between data electrode Dk and scan electrode SC1 exceeds the discharge start voltage, and discharge occurs between data electrode Dk and scan electrode SC1.

Since voltage Ve2 is applied to sustain electrode SU1 through sustain electrode SUn, the voltage difference between sustain electrode SU1 and scan electrode SC1 is derived by adding the difference between the wall voltage on sustain electrode SU1 and that on scan electrode SC1 to the difference (voltage Ve2−voltage Va) of the external applied voltage. At this time, by setting voltage Ve2 at a voltage value slightly lower than the discharge start voltage, a state where discharge does not occur but is apt to occur can be caused between sustain electrode SU1 and scan electrode SC1. Therefore, the discharge occurring between data electrode Dk and scan electrode SC1 can cause discharge between sustain electrode SU1 and scan electrode SC1 that exist in a region crossing data electrode Dk. Thus, address discharge occurs in the discharge cell to emit light, positive wall voltage is accumulated on scan electrode SC1, negative wall voltage is accumulated on sustain electrode SUL and negative wall voltage is also accumulated on data electrode Dk.

Thus, the address operation of causing address discharge in the discharge cell to emit light in the first row and accumulating wall voltage on each electrode is performed. While, the voltage in the part where scan electrode SC1 intersects with data electrode D1 through data electrode Dm to which no address pulse voltage Vd has been applied does not exceed the discharge start voltage, so that address discharge does not occur. This address operation is performed until it reaches the discharge cell in the n-th row, and the address period is completed.

In the subsequent sustain period, sustain pulses in a quantity calculated by multiplying the luminance weight by a predetermined luminance magnification are alternately applied to display electrode pairs 24, sustain discharge is caused to emit light in the discharge cell having undergone the address discharge.

In the sustain period, positive sustain pulse voltage Vs is firstly applied to scan electrode SC1 through scan electrode SCn, and the ground potential as a base potential, namely 0 (V), is applied to sustain electrode SU1 through sustain electrode SUn. In the discharge cell having undergone the address discharge, the voltage difference between scan electrode SCi and sustain electrode SUi is obtained by adding the difference between the wall voltage on scan electrode SCi and that on sustain electrode SUi to sustain pulse voltage Vs. Thus, the voltage difference between scan electrode SCi and sustain electrode SUi exceeds the discharge start voltage, and sustain discharge occurs between scan electrode SCi and sustain electrode SUi.

Ultraviolet rays generated by this discharge cause phosphor layer 35 to emit light. Negative wall voltage is accumulated on scan electrode SCi, and positive wall voltage is accumulated on sustain electrode SUi. Positive wall voltage is also accumulated on data electrode Dk. In the discharge cell where address discharge has not occurred in the address period, sustain discharge does not occur and the wall voltage at the end of the initializing period is kept.

Subsequently, 0 (V) as the base potential is applied to scan electrode SC1 through scan electrode SCn, and sustain pulse voltage Vs is applied to sustain electrode SU1 through sustain electrode SUn. In the discharge cell having undergone the sustain discharge, the voltage difference between sustain electrode SUi and scan electrode SCi exceeds the discharge start voltage. Thus, sustain discharge occurs between sustain electrode SUi and scan electrode SCi again, negative wall voltage is accumulated on sustain electrode SUi, and positive wall voltage is accumulated on scan electrode SCi.

Hereinafter, similarly, sustain pulses in a quantity calculated by multiplying the luminance weight by luminance magnification are alternately applied to scan electrode SC1 through scan electrode SCn and sustain electrode SU1 through sustain electrode SUn. Thus, sustain discharge is continuously performed in the discharge cell having undergone the address discharge in the address period.

After generation of a sustain pulse in the sustain period, ramp voltage, which gently increases from 0 (V) to voltage Vers, is applied to scan electrode SC1 through scan electrode SCn while 0 (V) is applied to sustain electrode SU1 through sustain electrode SUn and data electrode D1 through data electrode Dm. This ramp voltage is hereinafter referred to as “erasing ramp voltage L3”. The gradient of erasing ramp voltage L3 is set to be steeper than that of up-ramp voltage L1. One example of the gradient of erasing ramp voltage L3 is a numerical value of about 10 V/μsec. By setting voltage Vers at a voltage exceeding the discharge start voltage, feeble discharge occurs between sustain electrode SUi and scan electrode SCi of the discharge cell having undergone the sustain discharge. This feeble discharge continues while the applied voltage to scan electrode SC1 through scan electrode SCn increases beyond the discharge start voltage. When the increasing voltage arrives at predetermined voltage Vers, the voltage applied to scan electrode SC1 through scan electrode SCn is decreased to 0 (V) as the base potential.

At this time, the charged particles generated by the feeble discharge are accumulated on sustain electrode SUi and scan electrode SCi so as to reduce the voltage difference between sustain electrode SUi and scan electrode SCi. Therefore, in the discharge cell having undergone the sustain discharge, the wall voltage between scan electrode SC1 through scan electrode SCn and sustain electrode SU1 through sustain electrode SUn is reduced nearly to the difference between the voltage applied to scan electrode SCi and the discharge start voltage, namely (voltage Vers−discharge start voltage). Thus, in the discharge cell having undergone the sustain discharge, a part or the whole of the wall charge on scan electrode SCi and sustain electrode SUi is erased while positive wall voltage is left on data electrode Dk. In other words, the discharge caused by erasing ramp voltage L3 serves as “erasing discharge” of erasing unnecessary wall charge accumulated in the discharge cell having undergone the sustain discharge. Hereinafter, the final discharge of the sustain period caused by erasing ramp voltage L3 is referred to as “erasing discharge”.

Then, the applied voltage to scan electrode SC1 through scan electrode SCn is returned to 0 (V), and the sustain operation in the sustain period is completed.

In the initializing period of the second SF, the driving voltage waveform where the first half of the initializing period of the first SF is omitted is applied to each electrode. Voltage Ve1 is applied to sustain electrode SU1 through sustain electrode SUn, and 0 (V) is applied to data electrode D1 through data electrode Dm. Down-ramp voltage L4, which gently decreases from voltage Vi3′ (for example, 0 (V)) to negative voltage V14, is applied to scan electrode SC1 through scan electrode SCn. Here, voltage V13′ is lower than the discharge start voltage, and negative voltage V14 exceeds the discharge start voltage. One example of the gradient of down-ramp voltage L4 is a numerical value of about −2.5 V/μsec.

Thus, feeble initializing discharge occurs in the discharge cell having undergone the sustain discharge in the sustain period of the immediately preceding subfield (first SF in FIG. 3). Then, the wall voltages on scan electrode SCi and sustain electrode SUi are reduced, and the wall voltage on data electrode Dk (k is 1 through m) is also adjusted to a value appropriate for the address operation. In the discharge cell having undergone no sustain discharge in the sustain period of the immediately preceding subfield, initializing discharge does not occur. The initializing operation in the second SF thus becomes the selective initializing operation of causing initializing discharge in the discharge cell that has undergone sustain discharge in the sustain period of the immediately preceding subfield.

In the address period and sustain period of the second SF, a driving voltage waveform similar to that in the address period and sustain period of the first SF is applied to each electrode except for the number of generated sustain pulses. In each subfield of the third SF and later, a driving voltage waveform similar to that in the second SF is applied to each electrode except for the number of generated sustain pulses.

The outline of the driving voltage waveform applied to each electrode of panel 10 has been described.

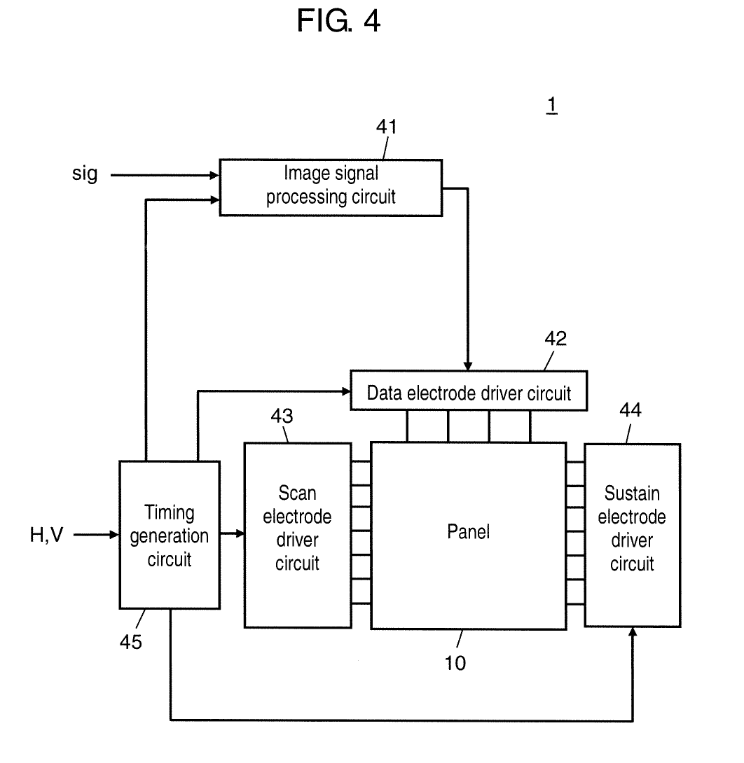

Next, a configuration of the plasma display apparatus of the present embodiment is described. FIG. 4 is a circuit block diagram of plasma display apparatus 1 of the first exemplary embodiment of the present invention. Plasma display apparatus 1 has the following elements:
panel 10;
image signal processing circuit 41;
data electrode driver circuit 42;
scan electrode driver circuit 43;
sustain electrode driver circuit 44;
timing generation circuit 45; and
a power supply circuit (not shown) for supplying power required for each circuit block.

Image signal processing circuit 41 assigns a gradation value to each discharge cell based on input image signal sig. Then, image signal processing circuit 41 converts the gradation value into image data that indicates light emission or no light emission in each subfield.

For example, when input image signal sig includes a luminance signal (Y signal) and a chroma signal (C signal, R-Y signal and B-Y signal, or u signal and v signal), image signal processing circuit 41 sets the luminance gradation value and chroma gradation value for each pixel based on the luminance signal and chroma signal. Image signal processing circuit 41 assigns each gradation value (gradation value represented in one field) of R, G, and B to each discharge cell based on the luminance gradation value and chroma gradation value set for each pixel.

When input image signal sig includes an R signal, a G signal, and a B signal, image signal processing circuit 41 assigns each gradation value of R, G, and B to each discharge cell based on the R signal, the G signal, and the B signal.

Image signal processing circuit 41 converts each gradation value of R, G, and B assigned to each discharge cell into image data that indicates light emission or no light emission in each subfield.

In the present exemplary embodiment, image signal processing circuit 41 calculates, for each pixel, a numerical value called “afterimage strength level”, which serves as a guideline of the occurrence of an afterimage phenomenon, based on the luminance gradation value set for each pixel in response to image signal sig. Based on the calculated afterimage strength level of each pixel, the luminance gradation value of each pixel is changed. Details on this operation are described later.

Image signal processing circuit 41 calculates each gradation value of R, G, and B assigned to each discharge cell based on the luminance gradation value after the change.

When image signal sig includes an R signal, a G signal, and a B signal, image signal processing circuit 41 temporarily calculates the luminance gradation value of each pixel based on the R signal, G signal, and B signal, and calculates the afterimage strength level based on the luminance gradation value. Then, image signal processing circuit 41 changes the luminance gradation value of each pixel based on the calculated afterimage strength level of each pixel, and calculates each gradation value of R, G, and B assigned to each discharge cell based on the luminance gradation value after the change.

Timing generation circuit 45 generates various timing signals for controlling operations of respective circuit blocks based on horizontal synchronizing signal H and vertical synchronizing signal V. Timing generation circuit 45 supplies the generated timing signals to respective circuit blocks (image signal processing circuit 41, data electrode driver circuit 42, scan electrode driver circuit 43, and sustain electrode driver circuit 44).

Data electrode driver circuit 42 converts data of each subfield constituting the image data into a signal corresponding to each of data electrode D1 through data electrode Dm, and drives each of data electrode D1 through data electrode Dm based on the timing signal supplied from timing generation circuit 45.

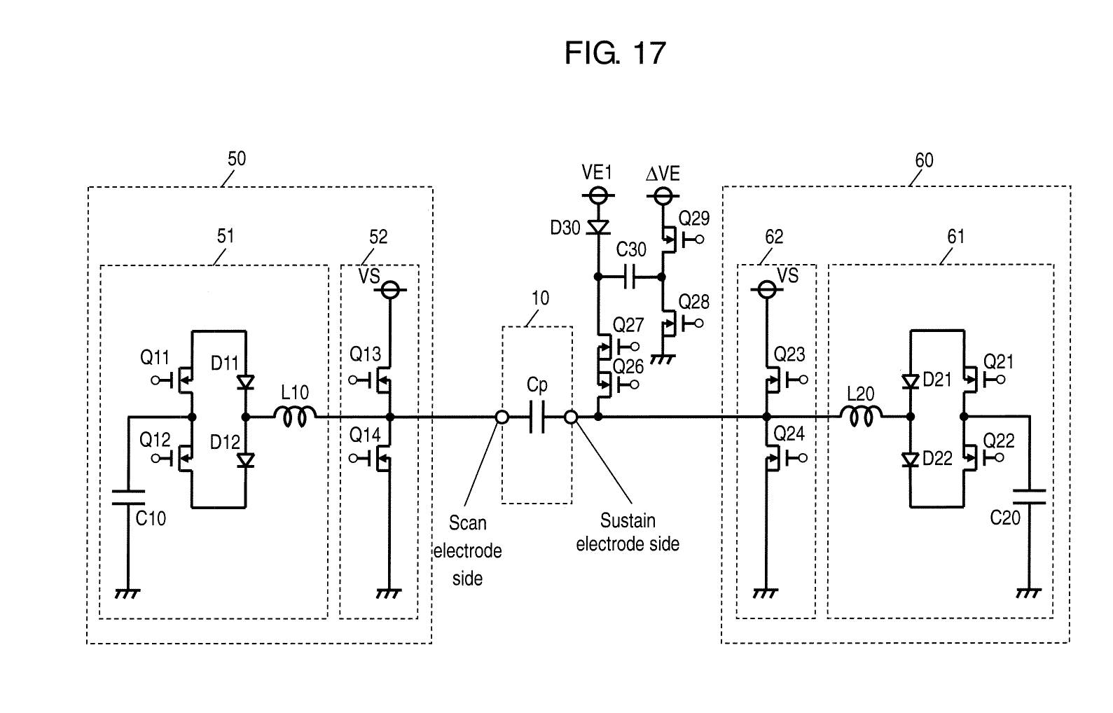

Scan electrode driver circuit 43 has an initializing waveform generation circuit (not shown), sustain pulse generation circuit 50 (FIG. 17), and a scan pulse generation circuit (not shown). The initializing waveform generation circuit generates an initializing waveform to be applied to scan electrode SC1 through scan electrode SCn in the initializing period. Sustain pulse generation circuit 50 generates a sustain pulse to be applied to scan electrode SC1 through scan electrode SCn in the sustain period. The scan pulse generation circuit has a plurality of scan electrode driver ICs (scan ICs), and generates a scan pulse to be applied to scan electrode SC1 through scan electrode SCn in the address period. Scan electrode driver circuit 43 drives each of scan electrode SC1 through scan electrode SCn based on the timing signal supplied from timing generation circuit 45.

Sustain electrode driver circuit 44 has sustain pulse generation circuit 60 (FIG. 17) and a circuit (not shown) for generating voltage Ve1 and voltage Vet, and drives sustain electrode SU1 through sustain electrode SUn based on the timing signal supplied from timing generation circuit 45.

Next, the afterimage phenomenon is described. In panel 10 where the xenon partial pressure of the discharge gas filled into the discharge cells is increased in order to increase the luminous efficiency of the panel, a static image is recognized as an afterimage when the static image is displayed for a long time. In other words, the afterimage phenomenon apt to occur. A considered reason is described below.

When static images are continuously displayed on panel 10, a discharge cell where the lighting frequency per unit time (e.g. one field) is relatively high and a discharge cell where the lighting frequency per unit time is relatively low are apt to occur. In other words, the lighting state continues in the former discharge cell, and the no-lighting state continues in the latter discharge cell. Between these discharge cells, the component concentration of the discharge gas differs (for example, difference in concentration of impure gas containing water vapor), and the discharge start voltage differs. The internal temperature differs between the discharge cell where the lighting state continues and the discharge cell where the no-lighting state continues, and the temperature difference becomes one factor for causing difference in discharge start voltage. The difference in discharge start voltage causes difference in timing of causing discharge. Thus, the emission intensity differs, and hence luminance differs between the discharge cell where the lighting state continues and the discharge cell where the no-lighting state continues. This behavior is considered to be the reason why the afterimage phenomenon occurs.

In the present exemplary embodiment, it is determined whether the image has many static regions and many regions where the luminance difference between adjacent pixels is large, and the luminance gradation value is changed based on the determination result. Specifically, image signal processing circuit 41 calculates, for each pixel, “afterimage strength level” as a guideline of the occurrence of an afterimage phenomenon, and changes the luminance gradation value of each pixel based on the calculated afterimage strength level. Next, details of this operation are described.

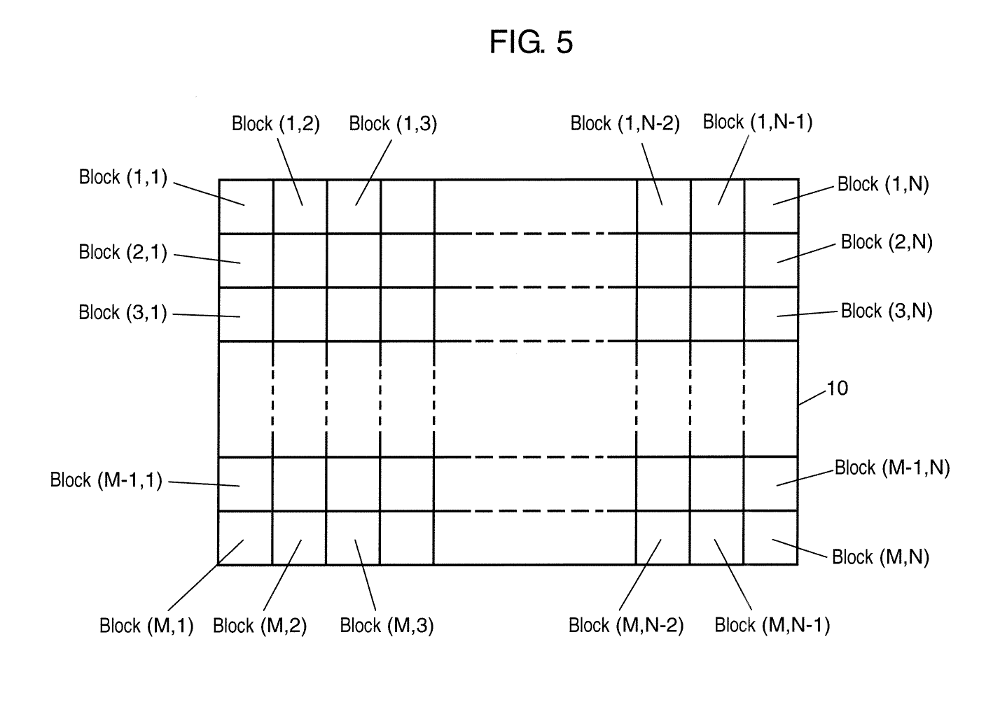

First, detection of the afterimage strength level is described. In the present exemplary embodiment, the image display region of panel 10 is divided into a plurality of regions, the afterimage strength level of each region is calculated, and the afterimage strength level of each pixel is calculated based on the calculated afterimage strength level of each region. FIG. 5 shows one example of this region.

FIG. 5 is a diagram for schematically showing one example of a plurality of regions disposed in the image display region of panel 10 in accordance with the first exemplary embodiment of the present invention. In FIG. 5, each region is expressed by “block (x,y)” (x and y are natural numbers), and also expressed simply by “block” in the following description. In FIG. 5, the lines in the image display region of panel 10 are accessorily shown so that each region can be easily recognized, and are not actually displayed on panel 10.

In the present exemplary embodiment, as shown in FIG. 5, each region is set by disposing a plurality of boundaries in the extending direction of display electrode pairs 24, disposing a plurality of boundaries are disposed in the extending direction of data electrodes 32, and thus dividing the image display region of panel 10 into regions so that the number of pixels in each region is constant.

FIG. 5 shows the example where each region is set by dividing panel 10 into N in the extending direction of display electrode pairs 24 and dividing panel 10 into M in the extending direction of data electrodes 32 (N and M are natural numbers). In this case, M×N regions, namely block (1,1) through block (M,N), are set on panel 10.

For example, when the number of pixels of panel 10 is 1920×1080 and the number of pixels in each region is set at 60×60, N is 32 and M is 18.

In the present exemplary embodiment, the afterimage strength level is calculated for each of M×N regions, namely block (1,1) through block (M,N). Then, the afterimage strength level of each pixel is calculated based on the calculated afterimage strength level of each region.

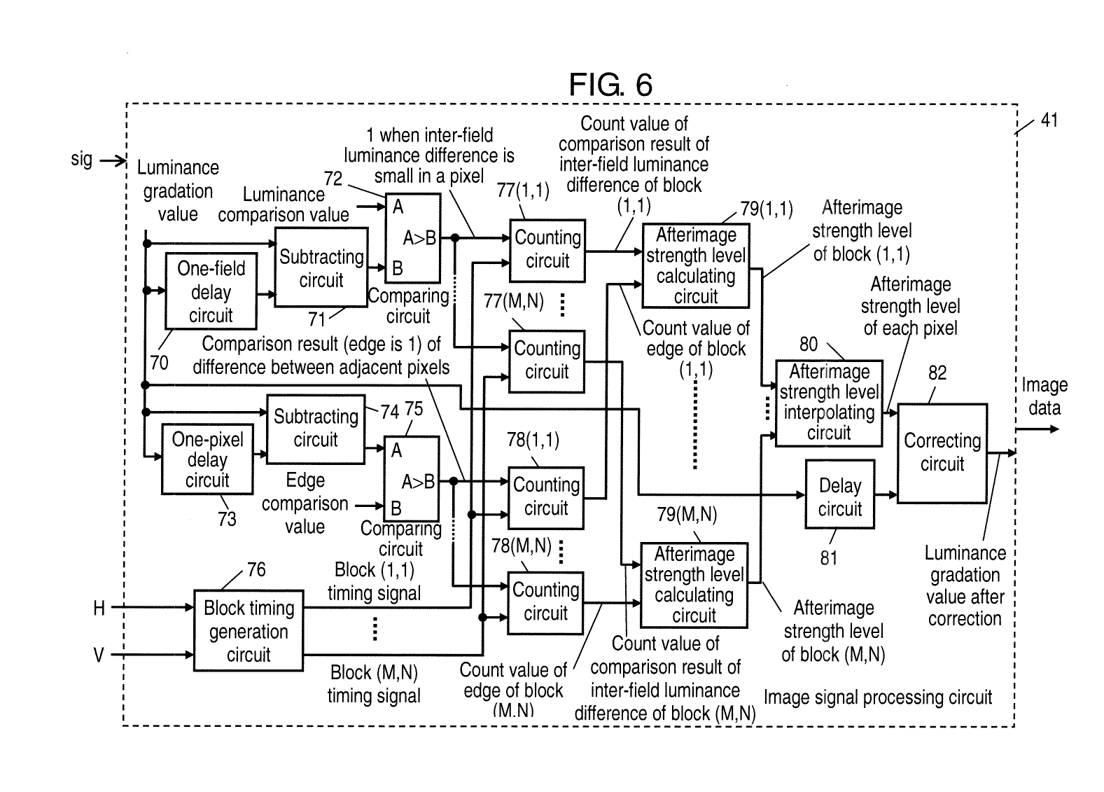

FIG. 6 is a circuit block diagram showing one configuration example of image signal processing circuit 41 in accordance with the first exemplary embodiment of the present invention. FIG. 6 shows a circuit block related to the calculation of the afterimage strength level and the change of the luminance gradation value based on the afterimage strength level, and omits the other circuit blocks.

Image signal processing circuit 41 includes one-field delay circuit 70, subtracting circuit 71, comparing circuit 72, one-pixel delay circuit 73, subtracting circuit 74, comparing circuit 75, block timing generation circuit 76, counting circuit 77 (1,1) through counting circuit 77 (M,N), counting circuit 78 (1,1) through counting circuit 78 (M,N), afterimage strength level calculating circuit 79 (1,1) through afterimage strength level calculating circuit 79 (M,N), afterimage strength level interpolating circuit 80, delay circuit 81, and correcting circuit 82.

One-field delay circuit 70 delays the luminance gradation value set for each pixel by the period corresponding to one field. Subtracting circuit 71 subtracts the luminance gradation value set for each pixel from the luminance gradation value set for each pixel in the immediately preceding field output from one-field delay circuit 70, and outputs the absolute value of the subtraction result as “inter-field luminance difference”. In other words, subtracting circuit 71 calculates, for each pixel, as the inter-field luminance difference, the difference between the luminance gradation value in the present field and that in the field immediately before the present field.

Comparing circuit 72 compares the inter-field luminance difference output from subtracting circuit 71 with a predetermined luminance comparison value, outputs “1” when the inter-field luminance difference is smaller than the luminance comparison value, and outputs “0” when the inter-field luminance difference is not smaller than the luminance comparison value.

Each counting circuit 77, in each region, counts the number of “1”s output from comparing circuit 72, and outputs the count result as “first count value” of each region. For example, counting circuit 77 (1,1) counts the number of “1”s output from comparing circuit 72 in block (1,1), and outputs the count result as the first count value of block (1,1). Counting circuit 77 (M,N) counts the number of “1”s output from comparing circuit 72 in block (M,N), and outputs the count result as the first count value of block (M,N).

In other words, counting circuit 77, in each region, counts the number of pixels where the inter-field luminance difference is smaller than the luminance comparison value, and outputs the count result as the first count value of each region.

One-pixel delay circuit 73 delays the luminance gradation value set for each pixel by the period corresponding to one pixel.

Subtracting circuit 74 subtracts the luminance gradation value set for each pixel from the luminance gradation value of the immediately preceding pixel output from one-pixel delay circuit 73, and outputs the absolute value of the subtraction result as “luminance difference between adjacent pixels”.

Comparing circuit 75 compares the luminance difference between adjacent pixels output from subtracting circuit 74 with a predetermined edge comparison value, outputs “1” when the luminance difference between adjacent pixels is larger than the edge comparison value, and outputs “0” when the luminance difference between adjacent pixels is not larger than the edge comparison value.

Each counting circuit 78, in each region, counts the number of “1”s output from comparing circuit 75, and outputs the count result as “second count value” of each region. For example, counting circuit 78 (1,1) counts the number of “1”s output from comparing circuit 75 in block (1,1), and outputs the count result as the second count value of block (1,1). Counting circuit 78 (M,N) counts the number of “1”s output from comparing circuit 75 in block (M,N), and outputs the count result as the second count value of block (M,N).

In other words, counting circuit 78, in each region, counts the number of “edges” where the difference between the luminance gradation values of adjacent pixels is equal to the edge comparison value or larger, and outputs the count result as the second count value of each region.

Block timing generation circuit 76 generates a block timing signal for identifying each region based on horizontal synchronizing signal H and vertical synchronizing signal V supplied from timing generation circuit 45, and supplies it to each counting circuit 77 and each counting circuit 78. For example, block timing generation circuit 76 supplies a block (1,1) timing signal, which is “Hi” only in the period of block (1,1), to counting circuit 77 (1,1) and counting circuit 78 (1,1), and supplies a block (M,N) timing signal, which is “Hi” only in the period of block (M,N), to counting circuit 77 (M,N) and counting circuit 78 (M,N).

Each afterimage strength level calculating circuit 79 calculates the afterimage strength level of each region based on the first count value and second count value. For example, afterimage strength level calculating circuit 79 (1,1) calculates the afterimage strength level of block (1,1) based on the first count value and second count value in block (1,1), and afterimage strength level calculating circuit 79 (M,N) calculates the afterimage strength level of block (M,N) based on the first count value and second count value in block (M,N). Details of this operation are described later.

In the present exemplary embodiment, the afterimage strength level of each region is set as the afterimage strength level of the pixel (hereinafter referred to as “center pixel”) positioned in the center of each region. The afterimage strength level of each of pixels other than the center pixel is calculated based on the afterimage strength level of each region.

Afterimage strength level interpolating circuit 80 calculates the afterimage strength level of each of pixels other than “center pixel”. Specifically, the afterimage strength level of each pixel is calculated based on the afterimage strength level of the center pixel and the distances between the pixel whose afterimage strength level is to be calculated and a plurality of center pixels around it. Details of this operation are described later.

Delay circuit 81 delays the luminance gradation value set for each pixel by an appropriate time (for example, the time is required for calculating the afterimage strength level of each pixel).

Correcting circuit 82 changes the luminance gradation value of each pixel appropriately delayed by delay circuit 81, based on the afterimage strength level of each pixel calculated by afterimage strength level interpolating circuit 80.

As specific numerical values of the luminance comparison value and edge comparison value, for example, a numerical value corresponding to 50% of the number of pixels in one region can be used. For example, when 60×60 pixels are included in one region, the number of pixels in one region is 3600 and hence the numerical value corresponding to 50% is 1800. However, the present invention is not limited to this numerical value. The respective numerical values are set appropriately in response to the characteristics of panel 10 and the specification of plasma display apparatus 1.

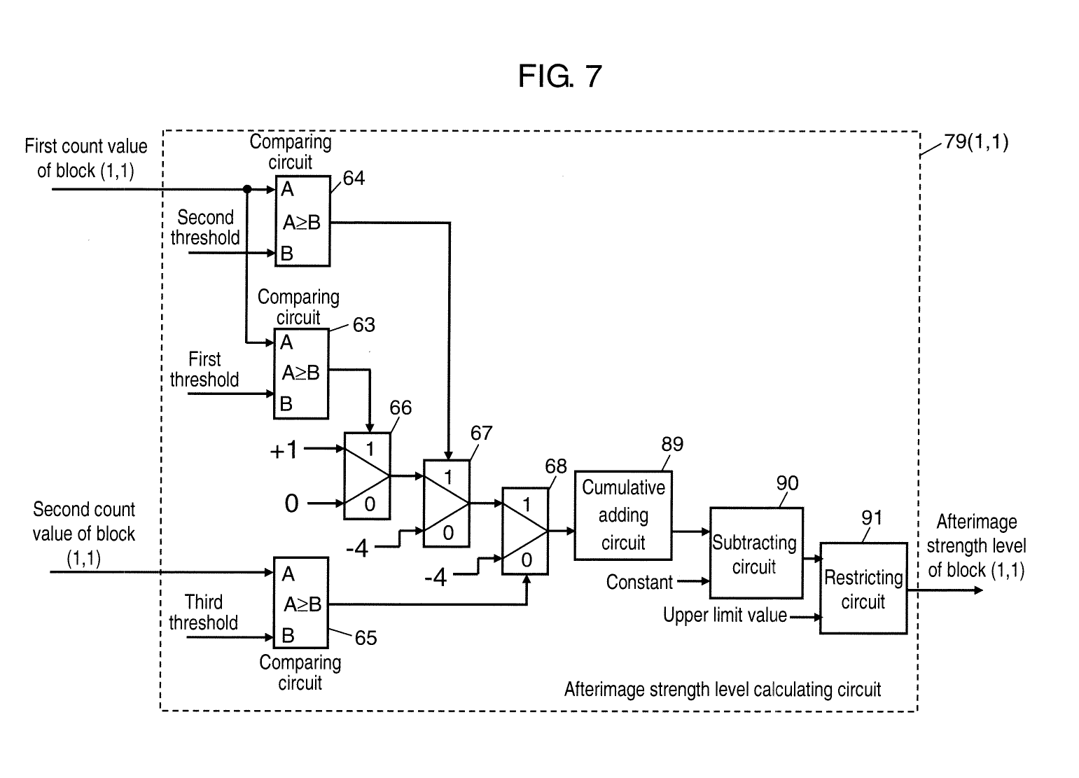

FIG. 7 is a circuit block diagram showing one configuration example of afterimage strength level calculating circuit 79 in accordance with the first exemplary embodiment of the present invention. FIG. 7 shows, as an example, afterimage strength level calculating circuit 79 (1,1) for calculating the afterimage strength level of block (1,1). The other afterimage strength level calculating circuit 79 (1,2) through afterimage strength level calculating circuit 79 (M,N) have a configuration similar to that in FIG. 7.

Afterimage strength level calculating circuit 79 includes comparing circuit 63, comparing circuit 64, comparing circuit 65, selector 66, selector 67, selector 68, cumulative adding circuit 89, subtracting circuit 90, and restricting circuit 91.

Comparing circuit 63 compares a first count value output from counting circuit 77 with a predetermined first threshold, outputs “1” when the first count value is equal to the first threshold or larger, and outputs “0” when the first count value is smaller than the first threshold. Here, the first count value is that of block (1,1) output from counting circuit 77 (1,1) in the example of FIG. 7.

Comparing circuit 64 compares the first count value (in the example of FIG. 7, the first count value of block (1,1)) with a second threshold smaller than the first threshold, outputs “1” when the first count value is equal to the second threshold or larger, and outputs “0” when the first count value is smaller than the second threshold.

Comparing circuit 65 compares a second count value output from counting circuit 78 with a predetermined third threshold, outputs “1” when the second count value is equal to the third threshold or larger, and outputs “0” when the second count value is smaller than the third threshold. Here, the second count value is that of block (1,1) output from counting circuit 78 (1,1), in the example of FIG. 7.

Selector 66 outputs a first set value, for example “+1”, to subsequent selector 67 when the output of comparing circuit 63 is “1”, and outputs a second set value, for example “0”, to subsequent selector 67 when the output of comparing circuit 63 is “0”.

Selector 67 outputs the output of selector 66 to subsequent selector 68 when the output of comparing circuit 64 is “1”, and outputs a third set value, for example “−4”, to subsequent selector 68 when the output of comparing circuit 64 is “0”.

Selector 68 outputs the output of selector 67 to subsequent cumulative adding circuit 89 when the output of comparing circuit 65 is “1”, and outputs a fourth set value, for example “−4”, to subsequent cumulative adding circuit 89 when the output of comparing circuit 65 is “0”.

Cumulative adding circuit 89 cumulatively adds numerical values output from selector 68, and outputs the addition result. For example, when the cumulative addition result of cumulative adding circuit 89 in block (1,1) is “10” in a certain field, the numerical values output from selector 68 are cumulatively added to the “10” in the subsequent field.

In other words, in the regions where the first count value is equal to the first threshold or larger and the second count value is equal to the third threshold or larger, selector 66, selector 67, selector 68, and cumulative adding circuit 89 cumulatively add the first set value to the afterimage strength level of each region. In the regions where the first count value is smaller than the first threshold and is not smaller than the second threshold, which is smaller than the first threshold, and the second count value is equal to the third threshold or larger, they cumulatively add the second set value to the afterimage strength level of each region. In the regions where the first count value is smaller than the second threshold and the second count value is equal to the third threshold or larger, they cumulatively add the third set value to the afterimage strength level of each region. In the regions where the second count value is smaller than the third threshold, they cumulatively add the fourth set value to the afterimage strength level of each region. Thus, the afterimage strength level of each region is updated for each field.

In the present exemplary embodiment, the region where the first count value is equal to the first threshold or larger and the second count value is equal to the third threshold or larger is set as a region where the possibility of causing the afterimage phenomenon is increased. In this region, the first set value is set at a positive number (e.g. “+1”), and the afterimage strength level is increased. The region where the first count value is smaller than the second threshold and the second count value is equal to the third threshold or larger, and the region where the second count value is smaller than the third threshold are set as regions where the possibility of causing the afterimage phenomenon is decreased. In these regions, the third set value and fourth set value are set at a negative number (e.g. “−4”), and the afterimage strength level is decreased. The region where the first count value is smaller than the first threshold and is not smaller than the second threshold and the second count value is equal to the third threshold or larger is set as a region where the possibility of causing the afterimage phenomenon is kept constant. In this region, the second set value is set at “0” and the afterimage strength level is kept constant.

Subtracting circuit 90 subtracts a predetermined constant (e.g. “50”) from a cumulative addition result output from cumulative adding circuit 89, namely from the afterimage strength level updated by cumulatively adding the numerical values output from selector 68. This subtraction considers the following behavior. Even when an image apt to generate an afterimage phenomenon is displayed, an afterimage does not instantly occur. When an image apt to generate the afterimage phenomenon is somewhat continuously displayed, an afterimage is apt to occur.

Restricting circuit 91 restricts the cumulative addition result output from subtracting circuit 90 to equal to a predetermined upper limit value (e.g. “100”) or lower. Here, the cumulative addition result is the afterimage strength level that is updated by cumulatively adding the numerical values output from selector 68 and from which the predetermined constant is subtracted. Therefore, the largest numerical value output from afterimage strength level calculating circuit 79 shown in FIG. 7 becomes the upper limit value. This operation is performed in order to prevent the correction using the afterimage strength level from becoming excessive correction. Thus, for example, the excessive correction of the luminance gradation value in correcting circuit 82 can be prevented.

Specific numerical values discussed above are simply one example, and the present invention is not limited to these numerical values. Numerical values are preferably set appropriately in response to the characteristics of panel 10 or the specification of plasma display apparatus 1.

Thus, the afterimage strength level of each region is output from afterimage strength level calculating circuit 79. In the example of FIG. 7, the afterimage strength level of block (1,1) is output from afterimage strength level calculating circuit 79 (1,1).

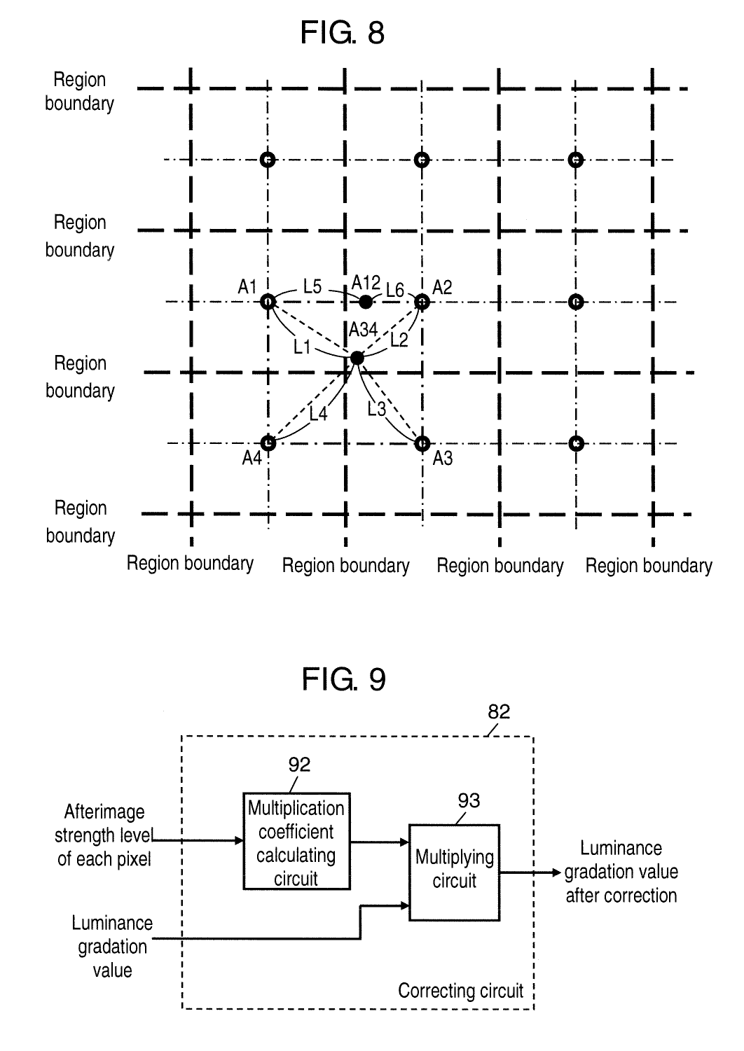

FIG. 8 is a diagram for schematically showing an operation by afterimage strength level interpolating circuit 80 in accordance with the first exemplary embodiment of the present invention. In FIG. 8, a part of panel 10 is enlarged, each broken line shows a boundary of each region, and each solid-white circle shows the center pixel positioned in the center of each region. Each chain line shows each line connecting between one center pixel and another center pixel in FIG. 8. Black circles show pixel A12 and pixel A34 as pixels whose afterimage strength level is to be calculated in FIG. 8. The broken lines and the like of FIG. 8 are shown accessorily in order to facilitate differentiation between regions, but are not actually displayed on panel 10.

In the present exemplary embodiment, the afterimage strength level of each region is set as the afterimage strength level of the center pixel positioned in the center of each region. For example, the afterimage strength level of block (1,1) calculated by afterimage strength level calculating circuit 79 (1,1) is set as the afterimage strength level of the center pixel of block (1,1). The afterimage strength level of each of pixels other than “center pixel” is calculated based on the afterimage strength level of each region, namely based on the afterimage strength level of the center pixel.

Specifically, the afterimage strength level of each region is calculated in the following procedure.

First, the distances between a pixel whose afterimage strength level is to be calculated and a plurality of center pixels around it are calculated. For example, the pixel whose afterimage strength level is to be calculated is assumed to be pixel A34, the distances between pixel A34 and four center pixels around pixel A34 are calculated.

In FIG. 8, the center pixels around pixel A34 are denoted as pixel A1, pixel A2, pixel A3, and pixel A4, the distance between pixel A34 and pixel A1 is denoted as L1, the distance between pixel A34 and pixel A2 is denoted as L2, the distance between pixel A34 and pixel A3 is denoted as L3, and the distance between pixel A34 and pixel A4 is denoted as L4.

Then, the afterimage frequencies of the center pixels are added at percentages corresponding to the distances between the pixel whose afterimage strength level is to be calculated and respective center pixels around it.

For example, when the afterimage strength level of pixel A34 is denoted as a34, the afterimage strength level of pixel A1 is denoted as a1, the afterimage strength level of pixel A2 is denoted as a2, the afterimage strength level of pixel A3 is denoted as a3, and the afterimage strength level of pixel A4 is denoted as a4, afterimage strength level a34 of pixel A34 can be expressed by the following equation.

a34=(a1×(L2+L3+L4)+a2×(L1+L3+L4)+a3×(L1+L2+L4)+a4×(L1+L2+L3))/(3×(L1+L2+L3+L4))

The afterimage strength level of a pixel positioned on the line connecting between center pixels is calculated based on two center pixels positioned on both sides of the pixel. For example, pixel A12 whose afterimage strength level is to be calculated is positioned on the line connecting between pixel A1 and pixel A2, the afterimage strength level of pixel A12 is calculated based on the afterimage frequencies of pixel A1 and pixel A2.

For example, when the distance between pixel A12 and pixel A1 is denoted as L5, the distance between pixel A12 and pixel A2 is denoted as L6, and the afterimage strength level of pixel A12 is denoted as a12, afterimage strength level a12 of pixel A12 can be expressed by the following equation.

a12=(a1×L6+a2×L5)/(L5+L6)

These operations are performed by afterimage strength level interpolating circuit 80, and the afterimage strength level of each pixel is calculated.

FIG. 9 is a circuit block diagram showing one configuration example of correcting circuit 82 in accordance with the first exemplary embodiment of the present invention.

Correcting circuit 82 has multiplication coefficient calculating circuit 92 and multiplying circuit 93, and changes the luminance gradation value in response to the magnitude of the afterimage strength level.

Based on the afterimage strength level of each pixel, multiplication coefficient calculating circuit 92 calculates a multiplication coefficient to be multiplied by the luminance gradation value. Specifically, the afterimage strength level of each pixel is subtracted from a predetermined reference value (e.g. “255”), and the result obtained by dividing the subtraction result by the reference value (e.g. “255”) is set as the multiplication coefficient to be multiplied by the luminance gradation value.

Multiplying circuit 93 multiplies the luminance gradation value by the multiplication coefficient calculated by multiplication coefficient calculating circuit 92.

The operation of correcting circuit 82 is described while pixel A34 of FIG. 8 is taken as an example. When the afterimage strength level of pixel A34 is denoted as a34, the luminance gradation value of pixel A34 is denoted as Y34, and the predetermined reference value is “255”, luminance gradation value Y34′ of pixel A34 after correction is expressed by the following equation.

Y34′=((255−a34)/255)×Y34

Thus, regarding a pixel where an afterimage phenomenon is apt to occur, the luminance gradation value can be corrected in response to the magnitude of the afterimage strength level. Therefore, in a pixel having a high afterimage strength level, the luminance difference between it and its adjacent pixel can be reduced and occurrence of the afterimage phenomenon can be reduced.

The predetermined reference value is set based on maximum luminance gradation value “255”. In the present invention, however, but the predetermined reference value is not limited to this numerical value. Preferably, the predetermined reference value is set appropriately in response to the characteristics of panel 10 and the specification of plasma display apparatus 1.

As discussed above, in the present exemplary embodiment, “afterimage strength level” as a guideline of the occurrence of an afterimage phenomenon is calculated for each pixel based on the luminance gradation value, and the luminance gradation value of each pixel is changed based on the calculated afterimage strength level. Thus, in an image where an afterimage phenomenon is considered to be apt to occur, namely in an image where the number of edges is large and a static region is continuously displayed, the luminance gradation value is corrected in response to the magnitude of the afterimage strength level to reduce the luminance difference between it and its adjacent pixel, and the occurrence of an afterimage phenomenon can be reduced.

In the above-mentioned description of the present exemplary embodiment, subtracting circuit 74 subtracts the luminance gradation value set for each pixel from the luminance gradation value of the immediately preceding pixel output from one-pixel delay circuit 73, and calculates the luminance-difference-between-adjacent-pixels between two pixels (horizontally adjacent pixels) adjacent in the extending direction of display electrode pairs 24. However, the present invention is not limited to this configuration. For example, the following configuration may be employed: subtracting circuit 74 subtracts the luminance gradation value set for each pixel from the luminance gradation value preceding by one horizontal period, and calculates the luminance-difference-between-adjacent-pixels between two pixels (vertically adjacent pixels) adjacent in the extending direction of data electrodes 32. Alternatively, the following configuration may be employed: subtracting circuit 74 subtracts the luminance gradation value set for each pixel from the luminance gradation value preceding by (one horizontal period+one pixel), subtracts the luminance gradation value set for each pixel from the luminance gradation value preceding by (one horizontal period−one pixel), and calculates the luminance-difference-between-adjacent-pixels between two pixels adjacent diagonally on panel 10. Alternatively, subtracting circuit 74 may use the maximum value among the luminance-difference-between-adjacent-pixels calculated between horizontally adjacent pixels, the luminance-difference-between-adjacent-pixels calculated between vertically adjacent pixels, and the luminance-difference-between-adjacent-pixels calculated between diagonally adjacent pixels.

### Second Exemplary Embodiment

In the first exemplary embodiment, the configuration has been described where the luminance gradation value is changed in response to the afterimage strength level of each pixel. However, the following configuration may be employed: when an afterimage phenomenon occurs, the luminance gradation value is changed in response to the afterimage strength level only in a pixel where the luminance gradation value is high (the pixel having a luminance gradation value equal to a predetermined high luminance threshold or higher) and the conspicuous afterimage phenomenon occurs.

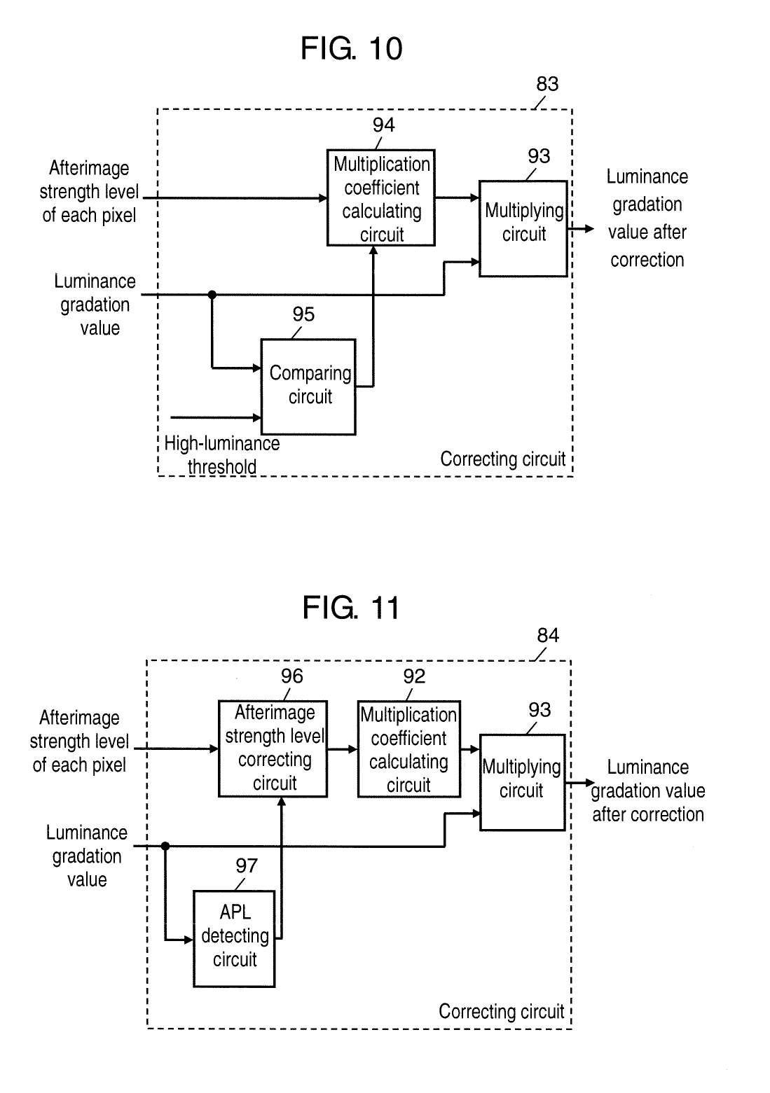

FIG. 10 is a circuit block diagram showing one configuration example of correcting circuit 83 in accordance with a second exemplary embodiment of the present invention. In the second exemplary embodiment, the procedure until the afterimage strength level of each pixel is calculated is similar to that of the first exemplary embodiment, so that only correcting circuit 83 having a configuration different from that of the first exemplary embodiment is described.

Correcting circuit 83 has multiplication coefficient calculating circuit 94, comparing circuit 95, and multiplying circuit 93, and changes the luminance gradation value only of a pixel having a high luminance gradation value in response to the magnitude of the afterimage strength level.

Comparing circuit 95 compares the luminance gradation value of each pixel with a predetermined high luminance threshold (for example, the threshold is about 60% of the maximum gradation value, and “150” when the maximum gradation value is “255”), and outputs the comparison result to multiplication coefficient calculating circuit 94.

Based on the afterimage strength level of each pixel and the comparison result by comparing circuit 95, multiplication coefficient calculating circuit 94 calculates a multiplication coefficient to be multiplied by the luminance gradation value. Specifically, when the luminance gradation value is equal to the high luminance threshold or smaller, multiplication coefficient calculating circuit 94 outputs “1” so that the luminance gradation value is not corrected. When the luminance gradation value is larger than the high luminance threshold, multiplication coefficient calculating circuit 94 calculates a multiplication coefficient for the excess of the luminance gradation value beyond the high luminance threshold, similarly to the first exemplary embodiment. Here, multiplication coefficient is to be multiplied by the luminance gradation value based on the afterimage strength level of each pixel.

Multiplying circuit 93 multiplies the luminance gradation value by the multiplication coefficient calculated by multiplication coefficient calculating circuit 94, similarly to multiplying circuit 93 of the first exemplary embodiment.

The operation of correcting circuit 83 is described while pixel A34 of FIG. 8 is taken as an example. When the afterimage strength level of pixel A34 is denoted as a34, the luminance gradation value of pixel A34 is denoted as Y34, the predetermined reference value is “255”, and the high luminance threshold is “150”, luminance gradation value Y34″ of pixel A34 after correction is expressed by the following equation.

Y34″=((255−a34)/255)×(Y34−150)+150

Here, gradation value Y34 is assumed to be higher than the high luminance threshold (when gradation value Y34 is equal to the high luminance threshold or lower, luminance gradation value Y34″ after correction is equal to gradation value Y34).

Thus, regarding a pixel where the luminance gradation value is high and the luminance difference between it and its adjacent pixel is large, the luminance gradation value can be corrected in response to the magnitude of the afterimage strength level.

The high luminance threshold is set based on maximum luminance gradation value “255”. In the present invention, however, the high luminance threshold is not limited to this numerical value. Preferably, the high luminance threshold is set appropriately in response to the characteristics of panel 10 and the specification of plasma display apparatus 1.

As discussed above, in the present exemplary embodiment, the afterimage strength level as a guideline of the occurrence of an afterimage phenomenon is calculated for each pixel based on the luminance gradation value, and the luminance gradation value of each pixel is changed based on the calculated afterimage strength level and the magnitude of the luminance gradation value. Thus, in an image where an afterimage phenomenon is considered to be apt to occur, namely in an image where the number of edges is large and a static region is continuously displayed, the luminance difference between it and its adjacent pixel can be reduced and the occurrence of an afterimage phenomenon can be reduced by correcting the luminance gradation value in response to the magnitude of the afterimage strength level and the magnitude of the luminance gradation value.

### Third Exemplary Embodiment

In an image where average picture level (hereinafter referred to as “APL”) during display is high, the luminance is high in whole, hence variation in luminance between adjacent pixels is small, and the number of edges is also small. In other words, in an image of high APL, an afterimage phenomenon is considered to hardly occur comparing with an image of low APL. Therefore, the following configuration may be employed: the APL of an image signal is detected, and the afterimage strength level is changed in response to the APL so that the afterimage strength level is lower when the APL is high than when the APL is low.

FIG. 11 is a circuit block diagram showing one configuration example of correcting circuit 84 in accordance with a third exemplary embodiment of the present invention. In the third exemplary embodiment, the procedure until the afterimage strength level of each pixel is calculated is similar to that of the first exemplary embodiment, so that only correcting circuit 84 having a configuration different from that of the first exemplary embodiment is described.

Correcting circuit 84 has APL detecting circuit 97, afterimage strength level correcting circuit 96, multiplication coefficient calculating circuit 92, and multiplying circuit 93. Correcting circuit 84 changes the afterimage strength level in response to the magnitude of the APL so that the afterimage strength level is lower when the APL is high than when the APL is low, and changes the luminance gradation value in response to the magnitude of the afterimage strength level after the change.

APL detecting circuit 97 detects the APL using a generally known method such as addition of the luminance gradation values of all pixels.

Afterimage strength level correcting circuit 96, in response to the APL detected by APL detecting circuit 97, changes the afterimage strength level of each pixel so that the afterimage strength level is lower when the APL is high than when the APL is low.

When the value of the APL detected by APL detecting circuit 97 is denoted as apl, afterimage strength level correcting circuit 96 changes the afterimage strength level by multiplying the afterimage strength level by the numerical value obtained by 100%−(apl-40%), for example. Here, apl-40% is set at 0 when apl-40% is equal to 0 or lower.

Multiplication coefficient calculating circuit 92 performs an operation similar to that of multiplication coefficient calculating circuit 92 of the first exemplary embodiment, and calculates a multiplication coefficient to be multiplied by the luminance gradation value based on the afterimage strength level changed by afterimage strength level correcting circuit 96.

Multiplying circuit 93 multiplies the luminance gradation value by the multiplication coefficient calculated by multiplication coefficient calculating circuit 92, similarly to multiplying circuit 93 of the first exemplary embodiment.

Thus, the afterimage strength level can be changed in response to the APL, and the luminance gradation value can be corrected in response to the magnitude of the afterimage strength level after the change.

The numerical value of “40%” subtracted from the APL is simply one example. Preferably, this numerical value is set appropriately in response to the characteristics of panel 10 and the specification of plasma display apparatus 1.

As discussed above, in the present exemplary embodiment, the afterimage strength level as a guideline of the occurrence of an afterimage phenomenon is changed based on the detected APL, and the luminance gradation value of each pixel is changed based on the afterimage strength level after the change. Thus, in an image of high APL where an afterimage phenomenon is considered to relatively hardly occur, the magnitude of the afterimage strength level can be decreased comparing with an image of low APL. For example, the occurrence of an afterimage phenomenon can be reduced while the luminance reduction of a display image of high APL is prevented.

### Fourth Exemplary Embodiment

The number of generated sustain pulses depends on the luminance magnification. As the luminance magnification decreases, the number of generated sustain pulses decreases, the luminance of a display image decreases, and the contrast ratio decreases. In other words, when the luminance magnification is low, an afterimage phenomenon is considered to hardly occur comparing with the case where the luminance magnification is high. Therefore, the afterimage strength level may be changed in response to the luminance magnification so that the afterimage strength level is lower when the luminance magnification is low than when the luminance magnification is high.

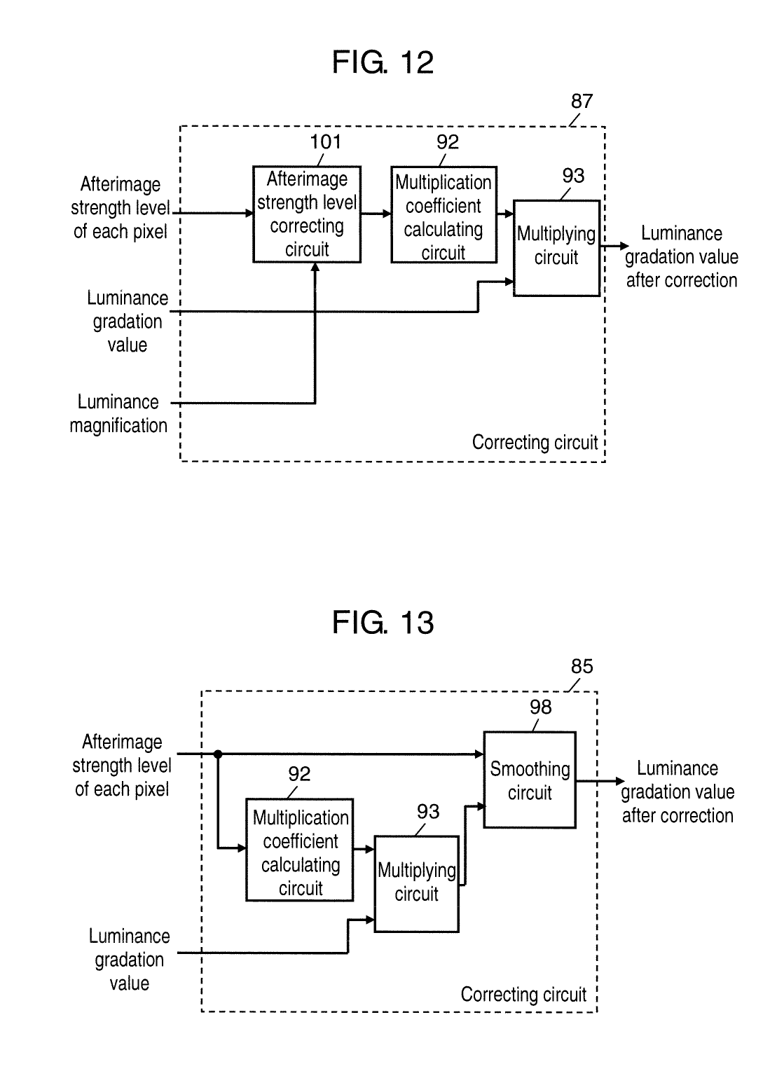

FIG. 12 is a circuit block diagram showing one configuration example of correcting circuit 87 in accordance with a fourth exemplary embodiment of the present invention. In the fourth exemplary embodiment, the procedure until the afterimage strength level of each pixel is calculated is similar to that of the first exemplary embodiment, so that only correcting circuit 87 having a configuration different from that of the first exemplary embodiment is described.

Correcting circuit 87 has afterimage strength level correcting circuit 101, multiplication coefficient calculating circuit 92, and multiplying circuit 93.

Afterimage strength level correcting circuit 101 changes the afterimage strength level of each pixel in response to the magnitude of the luminance magnification so that the afterimage strength level is lower when the luminance magnification is low than when the luminance magnification is high.

Afterimage strength level correcting circuit 101 changes the afterimage strength level by multiplying the afterimage strength level by the numerical value increasing as the luminance magnification increases. For example, the numerical value increases the sequence of 0.5 when the luminance magnification is 1, 0.7 when the luminance magnification is 2, 0.9 when the luminance magnification is 3, and 1.0 when the luminance magnification is 4.

Multiplication coefficient calculating circuit 92 performs an operation similar to that of multiplication coefficient calculating circuit 92 of the first exemplary embodiment. Multiplication coefficient calculating circuit 92 calculates a multiplication coefficient to be multiplied by the luminance gradation value based on the afterimage strength level changed by afterimage strength level correcting circuit 101.

Multiplying circuit 93 multiplies the luminance gradation value by the multiplication coefficient that is calculated by multiplication coefficient calculating circuit 92, similarly to multiplying circuit 93 of the first exemplary embodiment.

Thus, the afterimage strength level can be changed in response to the luminance magnification, and the luminance gradation value can be corrected in response to the magnitude of the afterimage strength level after the change.

The numerical values changing in response to the luminance magnification are simply one example. Preferably, these numerical values are set appropriately in response to the characteristics of panel 10 and the specification of plasma display apparatus 1.

As discussed above, in the present exemplary embodiment, the afterimage strength level as a guideline of the occurrence of an afterimage phenomenon is changed based on the luminance magnification, and the luminance gradation value of each pixel is changed based on the afterimage strength level after the change. Thus, when the luminance magnification is low and an afterimage phenomenon is considered to relatively hardly occur, the magnitude of the afterimage strength level can be decreased comparing with the case where the luminance magnification is high. Therefore, the occurrence of an afterimage phenomenon can be reduced while the luminance reduction of the image displayed when the luminance magnification is low is prevented, for example.

### Fifth Exemplary Embodiment

For example, by smoothing a luminance signal, the difference in luminance between adjacent pixels can be reduced and the occurrence of an afterimage phenomenon can be reduced. In the fifth exemplary embodiment, the luminance signal after correction is smoothed in response to the afterimage strength level.

FIG. 13 is a circuit block diagram showing one configuration example of correcting circuit 85 in accordance with the fifth exemplary embodiment of the present invention. In the fifth exemplary embodiment, the procedure until the afterimage strength level of each pixel is calculated is similar to that of the first exemplary embodiment, so that only correcting circuit 85 having a configuration different from that of the first exemplary embodiment is described.

Correcting circuit 85 has multiplication coefficient calculating circuit 92, multiplying circuit 93, and smoothing circuit 98, and smoothes the luminance signal after correction in response to the afterimage strength level.

Multiplication coefficient calculating circuit 92 performs an operation similar to that of multiplication coefficient calculating circuit 92 of the first exemplary embodiment, and calculates a multiplication coefficient to be multiplied by the luminance gradation value based on the afterimage strength level of each pixel.

Multiplying circuit 93 multiplies the luminance gradation value by the multiplication coefficient that is calculated by multiplication coefficient calculating circuit 92, similarly to multiplying circuit 93 of the first exemplary embodiment.

Smoothing circuit 98 smoothes the luminance gradation value output from multiplying circuit 93 in response to the afterimage strength level. As the means for smoothing, a generally known median filter can be used, for example. The smoothing is made weak when the afterimage strength level is low, or is made strong when the afterimage strength level is high. For example, the region of the median filter is set as one pixel×one pixel when the afterimage strength level is low, or is enlarged in the sequence of two pixels×two pixels, three pixels×three pixels, four pixels×four pixels, and five pixels×five pixels as the afterimage strength level increases.

Thus, the luminance signal is smoothed at a strength corresponding to the afterimage strength level, difference in luminance between adjacent pixels is reduced by the smoothing, and the occurrence of the afterimage phenomenon can be further reduced.

The smoothing means of smoothing circuit 98 is not limited to the median filter. The smoothing means may be any method such as another generally known two-dimensional filter for images as long as the filter can change the strength of the smoothing in response to the magnitude of the afterimage strength level. The two-dimensional filter is a moving average filter, a Gaussian filter, or an average value filter, for example. Preferably, the smoothing means of smoothing circuit 98 is set optimally in response to the characteristics of panel 10, the specification of plasma display apparatus 1, and the quality of the display image after smoothing.

As discussed above, in the present exemplary embodiment, the luminance gradation value of each pixel is changed based on the calculated afterimage strength level, and the luminance signal after correction is smoothed in response to the afterimage strength level. Thus, the luminance gradation value can be corrected in response to the magnitude of the afterimage strength level, and the luminance signal after correction can be smoothed in response to the magnitude of the afterimage strength level. Therefore, the difference in luminance between adjacent pixels can be further reduced, and the occurrence of the afterimage phenomenon can be further reduced.

### Sixth Exemplary Embodiment

In the first exemplary embodiment through fifth exemplary embodiment, the luminance gradation value of each pixel is changed based on the calculated afterimage strength level. However, by changing the chroma gradation value based on the calculated afterimage strength level, the occurrence of an afterimage phenomenon can be also reduced. In the sixth exemplary embodiment, a configuration for changing the chroma gradation value based on the calculated afterimage strength level is described.

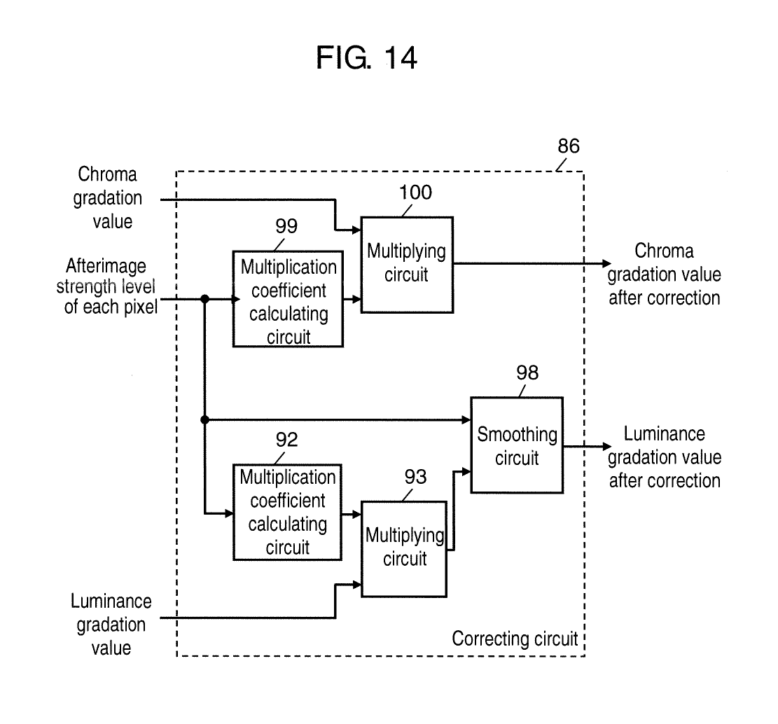

FIG. 14 is a circuit block diagram showing one configuration example of correcting circuit 86 in accordance with the sixth exemplary embodiment of the present invention. In the sixth exemplary embodiment, the procedure until the afterimage strength level of each pixel is calculated is similar to that of the first exemplary embodiment, so that only correcting circuit 86 having a configuration different from that of the first exemplary embodiment is described.

Correcting circuit 86 has multiplication coefficient calculating circuit 99 and multiplying circuit 100 in addition to multiplication coefficient calculating circuit 92, multiplying circuit 93, and smoothing circuit 98 shown in the fourth exemplary embodiment. Correcting circuit 86 corrects the luminance gradation value and the chroma gradation value (gradation value based on C signal, or R-Y signal and B-Y signal, or u signal and v signal) in response to the magnitude of the afterimage strength level.

Multiplication coefficient calculating circuit 92, multiplying circuit 93, and smoothing circuit 98 perform operations similar to those of the fourth exemplary embodiment, so that descriptions of the operations are omitted.

Multiplication coefficient calculating circuit 99 calculates a multiplication coefficient to be multiplied by the chroma gradation value based on the afterimage strength level of each pixel. Multiplication coefficient calculating circuit 99 may perform an operation similar to that of multiplication coefficient calculating circuit 92, but may further multiply the numerical value that is calculated by the operation similar to that of multiplication coefficient calculating circuit 92 by a predetermined constant for chroma.

Multiplying circuit 100 multiplies the chroma gradation value by the multiplication coefficient that is calculated by multiplication coefficient calculating circuit 99.

The operation of correcting circuit 86 is described while pixel A34 of FIG. 8 is taken as an example. When the afterimage strength level of pixel A34 is denoted as a34, the chroma gradation value of pixel A34 is denoted as C34, the predetermined reference value is “255”, and the constant for chroma is Ca, chroma gradation value C34′ of pixel A34 after correction is expressed by the following equation.

C34′=((255−a34)/255)×Ca×C34

Thus, the chroma gradation value can be corrected in response to the magnitude of the afterimage strength level. In an image of high chroma, namely in an image of dark color, the difference in gradation value between discharge cells of RGB constituting one pixel is apt to become larger than in an image of low chroma and light color. Therefore, by reducing the chroma in response to the magnitude of the afterimage strength level, the difference in gradation value between discharge cells of RGB can be reduced and the occurrence of the afterimage phenomenon can be further reduced.

Preferably, constant Ca for chroma is set optimally in response to the characteristics of panel 10, the specification of plasma display apparatus 1, and the quality of the display image after correction.

Correcting circuit 86 of the present exemplary embodiment may have a configuration where the correction of the luminance gradation value, the smoothing of the luminance gradation value, and the correction of the chroma gradation value are performed simultaneously in response to the magnitude of the afterimage strength level. Alternatively, correcting circuit 86 may have a configuration where one of these operations is selectively performed in response to the magnitude of the afterimage strength level. In other words, only the smoothing of the luminance gradation value is performed when the afterimage strength level is low, only the correction of the chroma gradation value is performed when the afterimage strength level is intermediate, and only the correction of the luminance gradation value is performed when the afterimage strength level is high, for example. Alternatively, correcting circuit 86 may have a configuration where two of these operations are combined in response to the magnitude of the afterimage strength level.

### Seventh Exemplary Embodiment

In the first exemplary embodiment, the configuration for changing the luminance gradation value in response to the afterimage strength level of each pixel has been described. However, the occurrence of an afterimage phenomenon can be reduced also by changing the waveform of the sustain pulse in response to the afterimage strength level. In the seventh exemplary embodiment, a configuration for changing the waveform of the sustain pulse in response to the afterimage strength level is described.

In the seventh exemplary embodiment, in order to raise a sustain pulse, two types of sustain pulses having different periods (hereinafter referred to as “rising period”) for operating a power recovery circuit described later. Specifically, in the sustain period, the following two types of sustain pulses are generated:
a first type of sustain pulse (hereinafter referred to as “first sustain pulse”) as the reference; and
a second type of sustain pulse (hereinafter referred to as “second sustain pulse”) where the rising is steepened by making “rising period” shorter than that of the first sustain pulse and the suppressing effect of the afterimage phenomenon is improved.
   The maximum value of the afterimage strength level is calculated, and the generation ratio between the first sustain pulse and second sustain pulse is changed based on the maximum value.

Thus, sustain discharge is caused stably while power consumption by panel 10 is reduced, and the afterimage phenomenon of the display image on panel 10 is reduced.

Hereinafter, the configuration of a driving circuit is described, and then the operation of the sustain period is described in detail.

In the seventh exemplary embodiment, the procedure until the afterimage strength level of each pixel is calculated is similar to that of the first exemplary embodiment. Therefore, in the seventh exemplary embodiment, in a circuit block for performing operation similar to that of the first exemplary embodiment, elements similar to those in the first exemplary embodiment are denoted with the same reference marks and are not described. The driving voltage waveform is similar to that of FIG. 3 except for the waveform of the sustain pulse, so that the descriptions are not omitted. In the seventh exemplary embodiment, operations that are not described in the first exemplary embodiment, and parts having a configuration different from that of the first exemplary embodiment are described.

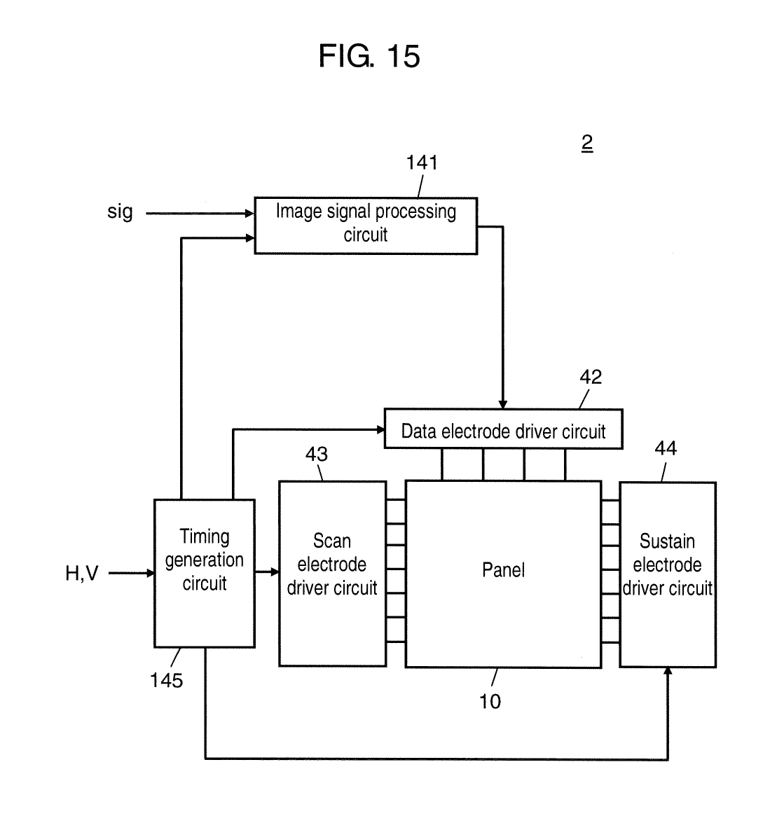

FIG. 15 is a circuit block diagram of plasma display apparatus 2 in accordance with the seventh exemplary embodiment of the present invention. Plasma display apparatus 2 has the following elements:

panel 10;

image signal processing circuit 141;

data electrode driver circuit 42;

scan electrode driver circuit 43;

sustain electrode driver circuit 44;

timing generation circuit 145; and

a power supply circuit (not shown) for supplying power required for each circuit block.

Image signal processing circuit 141 performs an operation substantially similar to that of image signal processing circuit 41 shown in the first exemplary embodiment. Image signal processing circuit 141 calculates “afterimage strength level”, then detects the maximum value of the calculated afterimage strength level, and transmits it to timing generation circuit 145. The details are described later.

Timing generation circuit 145 generates various timing signals for controlling the operations of respective circuit blocks based on horizontal synchronizing signal H, vertical synchronizing signal V, and the maximum value of the afterimage strength level output from image signal processing circuit 141, and supplies the timing signals to respective circuit blocks (image signal processing circuit 141, data electrode driver circuit 42, scan electrode driver circuit 43, and sustain electrode driver circuit 44). In the present exemplary embodiment, two types of sustain pulses having different “rising periods” are generated in response to the maximum value of the afterimage strength level. Here, two types of sustain pulses are the first sustain pulse, and the second sustain pulse where the rising is steeper than that of the first sustain pulse. Therefore, timing generation circuit 145 outputs the timing signal corresponding to the maximum value of the afterimage strength level to scan electrode driver circuit 43 and sustain electrode driver circuit 44.

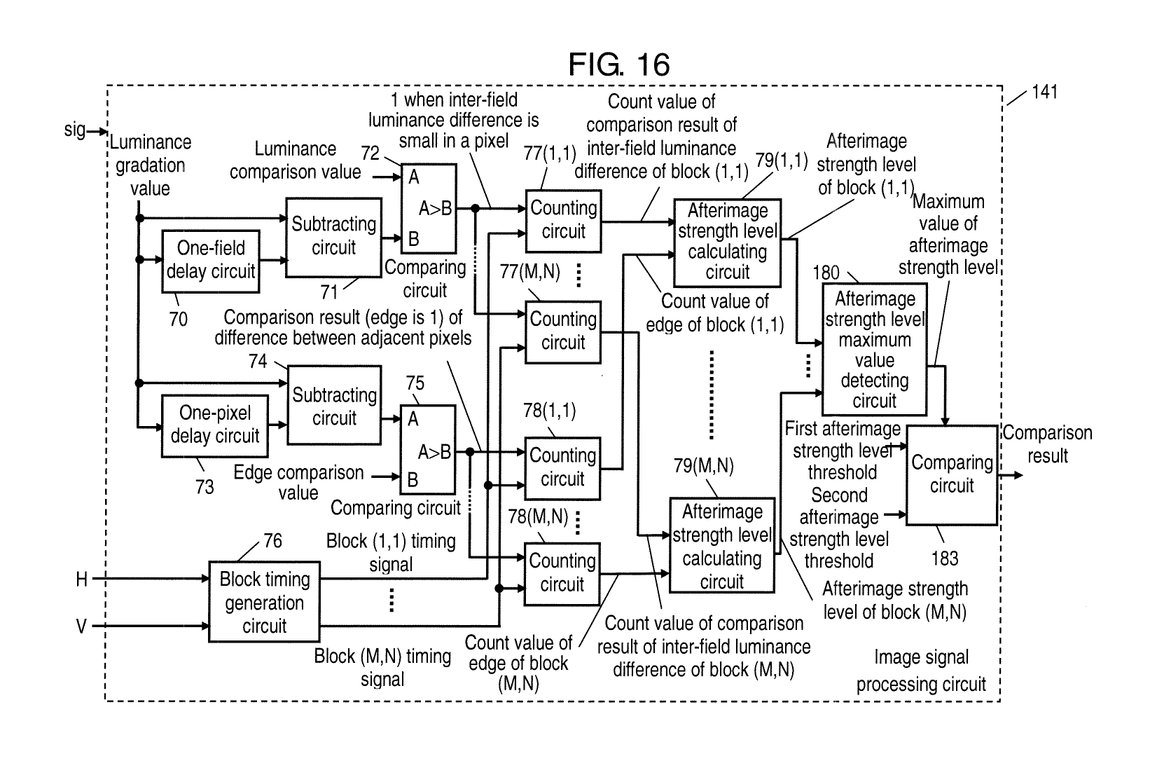

FIG. 16 is a circuit block diagram showing one configuration example of image signal processing circuit 141 in accordance with the seventh exemplary embodiment of the present invention. FIG. 16 shows only the circuit block related to the calculation of the afterimage strength level, and omits the other circuit blocks.

Image signal processing circuit 141 includes one-field delay circuit 70, subtracting circuit 71, comparing circuit 72, one-pixel delay circuit 73, subtracting circuit 74, comparing circuit 75, block timing generation circuit 76, counting circuit 77 (1,1) through counting circuit 77 (M,N), counting circuit 78 (1,1) through counting circuit 78 (M,N), afterimage strength level calculating circuit 79 (1,1) through afterimage strength level calculating circuit 79 (M,N), afterimage strength level maximum value detecting circuit 180, and comparing circuit 183.

Each circuit block of one-field delay circuit 70, subtracting circuit 71, comparing circuit 72, one-pixel delay circuit 73, subtracting circuit 74, comparing circuit 75, block timing generation circuit 76, counting circuits 77, counting circuits 78, and afterimage strength level calculating circuits 79 performs an operation similar to that of each circuit block described in the first exemplary embodiment, so that the descriptions are omitted.

Afterimage strength level maximum detecting circuit 180 detects the maximum value of M×N afterimage frequencies output from afterimage strength level calculating circuit 79 (1,1) through afterimage strength level calculating circuit 79 (M,N).

Afterimage strength level maximum detecting circuit 180 may have a function of storing the detected maximum value. In this case, when the main power supply of plasma display apparatus 2 is turned on, the maximum value stored when the main power supply of plasma display apparatus 2 is turned off can be read and used.

Comparing circuit 183 compares the maximum value of M×N afterimage frequencies detected by afterimage strength level maximum value detecting circuit 180 with a predetermined first afterimage strength level threshold and a second afterimage strength level threshold, which is lower than the first afterimage strength level threshold, and outputs the comparison result to timing generation circuit 145.

As one example of the specific numerical value of the first afterimage strength level threshold, a numerical value corresponding to 80% of the highest one of the numerical values output from afterimage strength level calculating circuits 79 can be used, for example. As one example of the second afterimage strength level threshold, a numerical value corresponding to 20% of the highest one of the numerical values output from afterimage strength level calculating circuits 79 can be used, for example. However, the thresholds of the present invention are not limited to these numerical values. Preferably, the thresholds are set appropriately in response to the characteristics of panel 10 and the specification of plasma display apparatus 2.

Next, a sustain pulse of the present exemplary embodiment is described.

First, sustain pulse generation circuit 50 and sustain pulse generation circuit 60 are described. FIG. 17 is a circuit diagram of sustain pulse generation circuit 50 and sustain pulse generation circuit 60 in accordance with the seventh exemplary embodiment of the present invention. In FIG. 17, the inter-electrode capacity of panel 10 is denoted with Cp, and a circuit for generating a scan pulse and an initializing voltage waveform is omitted.

Sustain pulse generation circuit 50 has power recovery circuit 51 and clamping circuit 52. Power recovery circuit 51 and clamping circuit 52 are connected to scan electrode SC1 through scan electrode SCn as one end of inter-electrode capacity Cp of panel 10 via a scan pulse generation circuit (not shown because the circuit is in a short circuit state in the sustain period).

Power recovery circuit 51 has capacitor C10 for power recovery, switching element Q11, switching element Q12, diode D11 for back flow prevention, diode D12 for back flow prevention, and inductor L10 for resonance. Power recovery circuit 51 LC-resonates inter-electrode capacity Cp and inductor L10 to raise or decrease a sustain pulse. Thus, power recovery circuit 51 drives scan electrode SC1 through scan electrode SCn by LC-resonance without supply of electric power from the power supply, so that the power consumption becomes 0 ideally. Capacitor C10 for power recovery has a sufficiently large capacity comparing with inter-electrode capacity Cp, and is charged up to about Vs/2, namely a half voltage value Vs, so as to work as the power supply of power recovery circuit 51.

Clamping circuit 52 has switching element Q13 for clamping scan electrode SC1 through scan electrode SCn on voltage Vs, and switching element Q14 for clamping scan electrode SC1 through scan electrode SCn on 0 (V) as base potential. Clamping circuit 52 clamps scan electrode SC1 through scan electrode SCn on voltage Vs by connecting them to power supply VS via switching element Q13. Clamping circuit 52 clamps scan electrode SC1 through scan electrode SCn on 0 (V) by grounding them via switching element Q14. Therefore, the impedance during voltage application by clamping circuit 52 is small, and large discharge current by strong sustain discharge can be made to flow stably.

Sustain pulse generating circuit 50 operates power recovery circuit 51 and clamping circuit 52 and generates a sustain pulse by switching between conduction and cut off of switching element Q11, switching element Q12, switching element Q13, switching element Q14 based on the timing signal output from timing generation circuit 145.

For example, when the sustain pulse is raised, sustain pulse generating circuit 50 sets switching element Q11 at ON and switching element Q12 at OFF to resonate inter-electrode capacity Cp and inductor L10, and supplies electric power from capacitor C10 for power recovery to scan electrode SC1 through scan electrode SCn via switching element Q11, diode D11, and inductor L10. When the voltage of scan electrode SC1 through scan electrode SCn approaches voltage Vs, sustain pulse generating circuit 50 sets switching element Q13 at ON to switch the circuit for driving scan electrode SC1 through scan electrode SCn from power recovery circuit 51 to clamping circuit 52, and clamps scan electrode SC1 through scan electrode SCn on voltage Vs. In the present exemplary embodiment, the rising of the sustain pulse is controlled by controlling the driving time by power recovery circuit 51.

Conversely, when the sustain pulse is decreased, sustain pulse generating circuit 50 sets switching element Q12 at ON and switching element Q11 at OFF to resonate inter-electrode capacity Cp and inductor L10, and recovers electric power from inter-electrode capacity Cp to capacitor C10 for power recovery via inductor L10, diode D11, and switching element Q12. When the voltage of scan electrode SC1 through scan electrode SCn approaches 0 (V), sustain pulse generating circuit 50 sets switching element Q14 at ON to switch the circuit for driving scan electrode SC1 through scan electrode SCn from power recovery circuit 51 to clamping circuit 52, and clamps scan electrode SC1 through scan electrode SCn on 0 (V) as the base potential.

Thus, sustain pulse generating circuit 50 generates a sustain pulse. Each of the switching elements can be formed of a generally known element such as a metal oxide semiconductor field effect transistor (MOSFET) or an insulated gate bipolar transistor (IGBT).

Sustain pulse generation circuit 60 has a structure substantially similar to that of sustain pulse generation circuit 50, includes power recovery circuit 61 and clamping circuit 62, and is connected to sustain electrode SU1 through sustain electrode SUn as one end of inter-electrode capacity Cp of panel 10. Power recovery circuit 61 has capacitor C20 for power recovery, switching element Q21, switching element Q22, diode D21 for back flow prevention, diode D22 for back flow prevention, and inductor L20 for resonance. Power recovery circuit 61 recovers and reuses the electric power when sustain electrode SU1 through sustain electrode SUn is driven, and raises or decreases the sustain pulse. Clamping circuit 62 has switching element Q23 for clamping sustain electrode SU1 through sustain electrode SUn on voltage Vs, and switching element Q24 for clamping sustain electrode SU1 through sustain electrode SUn on ground potential (0 (V)). Clamping circuit 62 clamps sustain electrode SU1 through sustain electrode SUn on voltage Vs or 0 (V). The operation of sustain pulse generation circuit 60 is similar to that of sustain pulse generation circuit 50, so that the description of it is omitted.

FIG. 17 also shows the following elements:
power supply VE1 for generating voltage Ve1; switching element Q26 for applying voltage Ve1 to sustain electrode SU1 through sustain electrode SUn;
switching element Q27;
power supply AVE for generating voltage ΔVe;
diode D30 for back flow prevention;
capacitor C30 for a charge pump for adding voltage ΔVe to voltage Ve1;
switching element Q28 and switching element Q29 for adding voltage ΔVe to voltage Ve1 to provide voltage Ve2.

For example, with a timing of applying voltage Ve1 shown in FIG. 3, switching element Q26 and switching element Q27 are conducted, and positive voltage Ve1 is applied to sustain electrode SU1 through sustain electrode SUn via diode D30, switching element Q26, and switching element Q27. At this time, switching element Q28 is conducted to be charged so that the voltage of capacitor C30 becomes voltage Ve1. With a timing of applying voltage Ve2 shown in FIG. 3, switching element Q28 is cut off while the switching element Q26 and switching element Q27 are conducted, and switching element Q29 is conducted to add voltage ΔVe to the voltage of capacitor C30, and voltage Ve1+ΔVe, namely voltage Ve2, is applied to sustain electrode SU1 through sustain electrode SUn. At this time, the current from capacitor C30 to voltage VE1 is cut off by work of diode D30 for back flow prevention.

A circuit for applying voltage Ve1 and voltage Ve2 is not limited to the circuit of FIG. 17. This circuit may have the following configuration: using a power supply for generating voltage Ve1, a power supply for generating voltage Ve2, and a plurality of switching elements for applying the respective voltages to sustain electrode SU1 through sustain electrode SUn, the respective voltages are applied to sustain electrode SU1 through sustain electrode SUn with required timings.

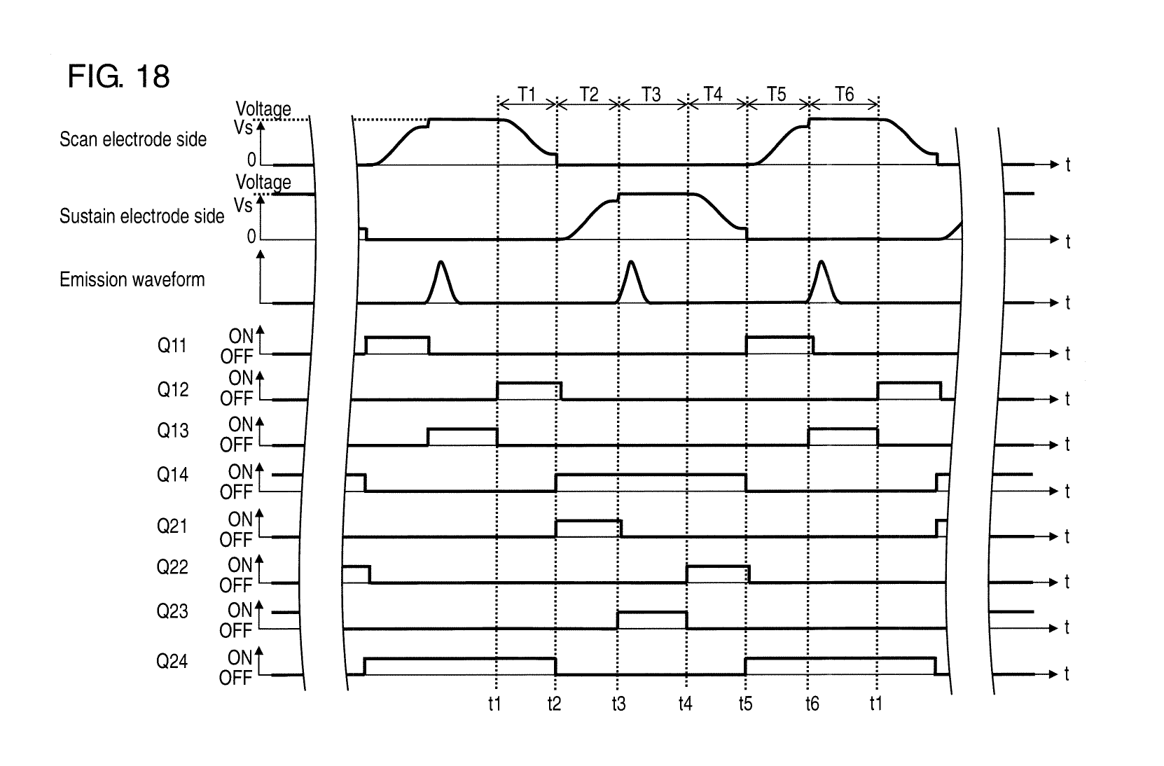

Next, the driving voltage waveform in the sustain period is described in detail. FIG. 18 is a timing chart for illustrating operations of sustain pulse generation circuit 50 and sustain pulse generation circuit 60 of the seventh exemplary embodiment of the present invention. FIG. 18 divides one cycle period of the repeating cycle of sustain pulses into 6 periods denoted as T1 through T6, and each period is described. This repeating cycle (hereinafter referred to as “sustain cycle”) means the interval between the sustain pulses repeatedly applied to display electrode pairs in the sustain period, and for example, means the cycle repeated by period T1 through period T6.

In the following description, an operation for conducting a switching element is denoted as ON, an operation for cutting off a switching element is denoted as OFF, a signal for setting a switching element at ON is denoted as “ON” in the drawing, and a signal for setting a switching element at OFF is denoted as “OFF” in the drawing. FIG. 18 employs descriptions using a positive-polarity waveform, but the present invention is not limited to this. An embodiment using a negative-polarity waveform is omitted, but a similar effect can be obtained even for the negative-polarity waveform by replacing “rising” of the positive-polarity waveform (described below) by “decreasing” of the negative-polarity waveform, and by replacing “decreasing” of the positive-polarity waveform by “rising” of the negative-polarity waveform.

(Period T1)

At time t1, switching element Q12 is set at ON. Then, the charge on the side of scan electrode SC1 through scan electrode SCn starts to flow to capacitor C10 via inductor L10, diode D12, and switching element Q12, and the voltage of scan electrode SC1 through scan electrode SCn starts to decrease. Inductor L10 and inter-electrode capacity Cp form a resonance circuit, so that the voltage of scan electrode SC1 through scan electrode SCn decreases nearly to 0 (V) at time t2 after a lapse of ½ of resonance cycle (e.g. 2000 nsec). However, power loss is caused by a resistance component or the like of the resonance circuit, so that the voltage of scan electrode SC1 through scan electrode SCn does not decrease to 0 (V).

In this period, switching element Q24 is kept at ON, and sustain electrode SU1 through sustain electrode SUn are clamped on 0 (V).

(Period T2)

At time t2, switching element Q14 is set at ON. Then, scan electrode SC1 through scan electrode SCn are directly grounded via switching element Q14, so that the voltage of scan electrode SC1 through scan electrode SCn is clamped on 0 (V) as the ground potential.

Furthermore, at time t2, switching element Q21 is set at ON. Then, current starts to flow from capacitor C20 for power recovery to sustain electrode SU1 through sustain electrode SUn via switching element Q21, diode D21, and inductor L20, and the voltage of sustain electrode SU1 through sustain electrode SUn starts to decrease. Inductor L20 and inter-electrode capacity Cp form a resonance circuit, so that the voltage of sustain electrode SU1 through sustain electrode SUn increases nearly to voltage Vs at time t3 after a lapse of ½ of resonance cycle (e.g. 2000 nsec). However, because of the output impedance or driving load of the driving circuit, the voltage of sustain electrode SU1 through sustain electrode SUn does not increase to voltage Vs.

In the present exemplary embodiment, the rising of the sustain pulse is controlled by controlling the length of period T2 and period T5, and the first sustain pulse and second sustain pulse are generated.

(Period T3)

At time t3, switching element Q23 is set at ON. Then, sustain electrode SU1 through sustain electrode SUn are directly connected to power supply VS via switching element Q23, so that the voltage of sustain electrode SU1 through sustain electrode SUn is clamped on voltage Vs and is forcibly increased to voltage Vs. In period T3, the voltage of sustain electrode SU1 through sustain electrode SUn is kept at voltage Vs.

(Period T4 Through Period T6)

The sustain pulse applied to scan electrode SC1 through scan electrode SCn and the sustain pulse applied to sustain electrode SU1 through sustain electrode SUn have the same waveform, and the operation in period T4 through period T6 is obtained by interchanging scan electrode SC1 through scan electrode SCn and sustain electrode SU1 through sustain electrode SUn in the operation in period T1 through period T3.

In the present exemplary embodiment, period T1 and period T4 are set as “decreasing period”, and period T2 and period T5 are set as “rising period”.

Switching element Q12 is required to be set at OFF after time t2 before time t5, and switching element Q21 is required to be set at OFF after time t3 before time t4. Switching element Q22 is required to be set at OFF after time t5 before next time t2, and switching element Q11 is required to be set at OFF after time t6 before next time t1. In order to decrease the output impedance of sustain pulse generation circuit 50 and sustain pulse generation circuit 60, preferably, switching element Q24 is required to be set at OFF immediately before time t2 and switching element Q13 is required to be set at OFF immediately before time t1. Preferably, switching element Q14 is required to be set at OFF immediately before time t5, and switching element Q23 is required to be set at OFF immediately before time t4.

In the sustain period, the operations of period T1 through period T6 are repeated in response to the number of required pulses. Thus, sustain pulse voltage varying from 0 (V) as the base potential to voltage Vs is alternately applied to display electrode pairs 24 to cause sustain discharge in the discharge cell.

The cycle of LC resonance of inductor L10 of power recovery circuit 51 and inter-electrode capacity Cp of panel 10 and the cycle (hereinafter referred to as “resonance cycle”) of LC resonance of inductor L20 of power recovery circuit 61 and inter-electrode capacity Cp can be obtained by expression “2π√(LCp)”. Here, L is inductance of each of inductor L10 and inductor L20. In the present exemplary embodiment, inductor L10 and inductor L20 are set so that the resonance cycle of power recovery circuit 51 and power recovery circuit 61 is 2000 nsec, for example.

Next, two types of sustain pulses of the present exemplary embodiment are described. First, the waveforms of two types of sustain pulses are described, and then the reason why driving is performed using two types of sustain pulses is described.

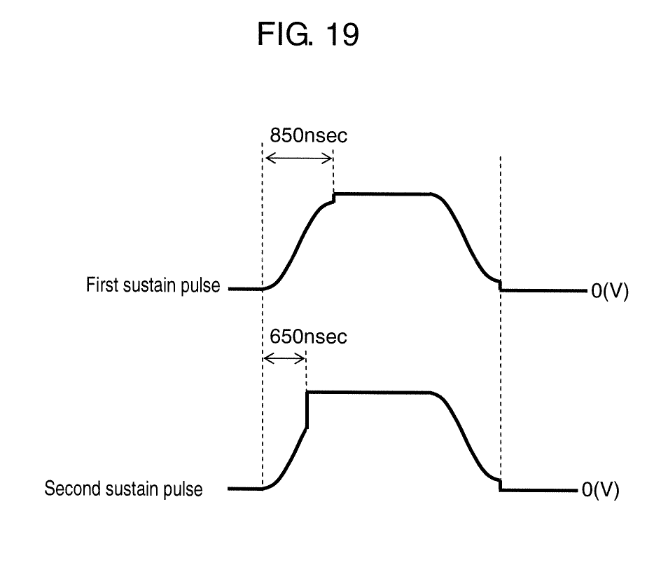

FIG. 19 is a schematic waveform chart for comparatively showing two types of sustain pulses in accordance with the seventh exemplary embodiment of the present invention. The upper part of FIG. 19 shows the first sustain pulse, and the lower part of FIG. 19 shows the second sustain pulse. The switching timing of each switching element of sustain pulse generation circuit 50 and sustain pulse generation circuit 60 is controlled to control the driving time of each power recovery circuit and each voltage clamping circuit, thereby changing “rising period”.

FIG. 19 shows the example where “rising period” of the first sustain pulse as the reference is set at 850 nsec and “rising period” of the second sustain pulse is set at 650 nsec. However, the present invention is not limited to these numerical values. Preferably, “rising period” of each of the first sustain pulse and the second sustain pulse is set optimally based on the characteristics of the panel and the specification of plasma display apparatus 1 and in consideration of the quality or the like of the display image.

In the present exemplary embodiment, the reason why two types of sustain pulses having different “rising periods” are generated is described as below.

In panel 10, when the driving load is increased by enlargement in screen and enhancement in definition, the rising waveform of the sustain pulse is apt to vary, and the timing (discharge start time) of generating discharge is apt to differ between discharge cells.

While, in panel 10 where the xenon partial pressure of the discharge gas is increased in order to increase the luminous efficiency, the discharge start voltage between the display electrode pairs also increases, and variation in timing of generating discharge is apt to increase.

Thus, when the timing of generating discharge differs between adjacent discharge cells, the emission intensity differs between a discharge cell where discharge occurs on ahead and a discharge cell where discharge occurs afterward, and variation in emission luminance on the display surface of panel 10 can occur. For example, there is the following reason:
discharge becomes weak because the discharge cell where discharge occurs on ahead causes the decrease of the wall charge of the discharge cell where discharge occurs afterward; or
discharge becomes weak because discharge having started once is temporarily stopped by discharge of the adjacent discharge cell and discharge is caused again by increase in applied voltage.

As discussed above, in panel 10 where the xenon partial pressure of the discharge gas is increased, when a static image is displayed for a long time, the discharge start voltage is apt to differ between a discharge cell where the lit state continues and a discharge cell where the unlit state continues.

The emission luminance of the discharge cells depends on the emission intensity per sustain discharge, so that the luminance differs between the discharge cells and an afterimage phenomenon occurs when the discharge start voltage differs to cause difference in emission intensity.

In order to reduce the difference in emission intensity caused by the difference in discharge start voltage, it is useful to cause sustain discharge in a state where the voltage variation is steep. Hereinafter, “rising period” of the sustain pulses and variation in discharge are described using drawings.

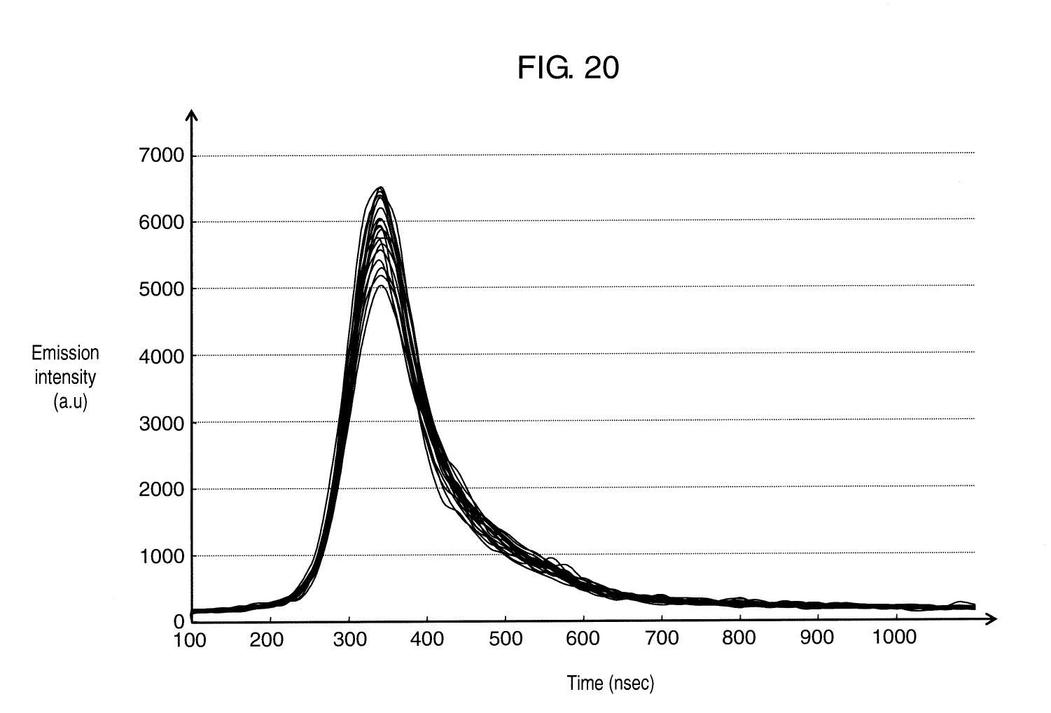

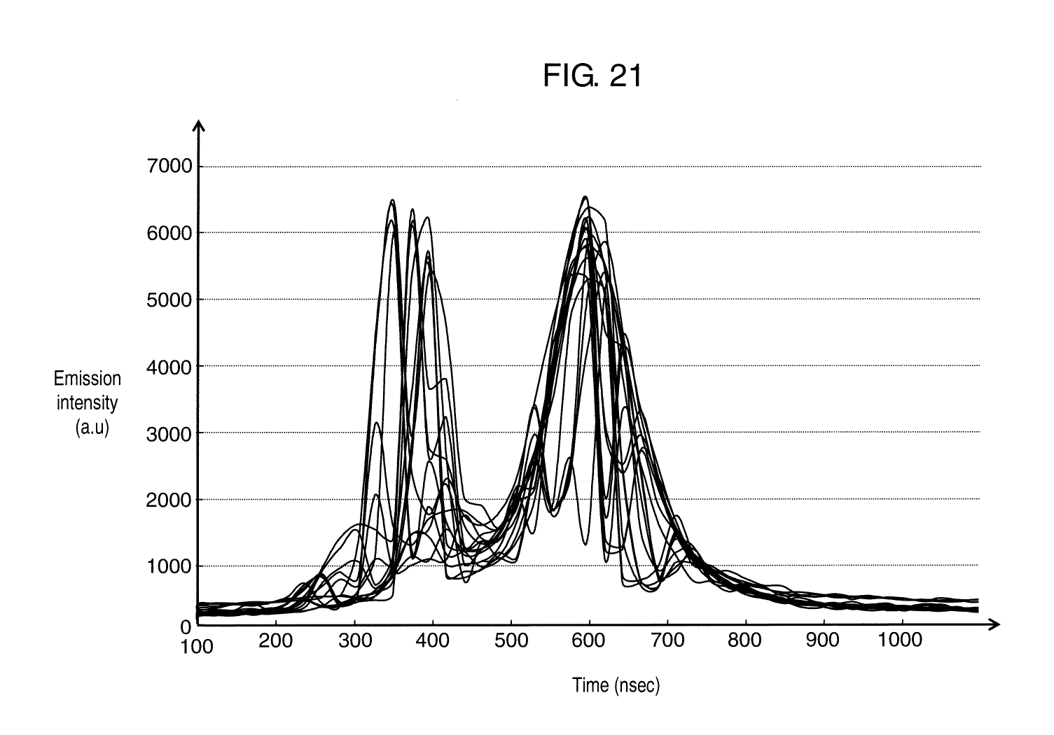

FIG. 20 and FIG. 21 are characteristic diagrams showing the relationship between “rising period” of the sustain pulses and variation in discharge in accordance with the seventh exemplary embodiment of the present invention. Here, experiments are performed while the resonance cycle of the power recovery circuit is set at 1200 nsec, the length of one cycle of the sustain pulses is set at 2.7 μsec, “decreasing period” is set at 900 nsec, and “rising period” is switched between two values, namely 400 nsec and 500 nsec. FIG. 20 shows the measurement result when “rising period” is set at 400 nsec, and FIG. 21 shows the measurement result when “rising period” is set at 500 nsec. In FIG. 20 and FIG. 21, the measurement results of a plurality of discharge cells are overlaid on one graph.

In FIG. 20 and FIG. 21, the vertical axis shows emission intensity, and the horizontal axis shows the elapsed time after the operation of the power recovery circuit starts. The unit (a.u.) of the vertical axis shows an arbitrary unit.

For example, when “rising period” is set at 400 nsec, relatively short, to steepen the rising of the sustain pulses as shown in FIG. 20, it is confirmed that light is substantially simultaneously emitted in most of the discharge cells and variation in discharge is suppressed.

Conversely, when “rising period” is set at 500 nsec longer than 400 nsec by 100 nsec to moderate the rising of the sustain pulses as shown in FIG. 21, it is confirmed that the light emitting times of the discharge cells are different from each other.

Thus, when the rising of the sustain pulse is steepened and discharge is caused in a state where variation in voltage is steep, the variation in discharge start voltage is eliminated, difference in timing of causing discharge between the discharge cells can be reduced, and hence variation in luminance can be suppressed.

When discharge is caused in a state where variation in voltage is steep, strong sustain discharge occurs and sufficient wall charge is produced in the discharge cells, and hence the subsequent sustain discharge can be stably caused.

In the present exemplary embodiment, as shown in FIG. 20, the second sustain pulse is set to have “rising period” of a length enabling the following operation: difference in timing of causing discharge between the discharge cells is suppressed, light is substantially simultaneously emitted in a large number of discharge cells, and strong discharge occurs to produce sufficient wall charge in the discharge cells. Thus, the second sustain pulse is set to have a high effect of suppressing the afterimage phenomenon.

However, when “rising period” of the sustain pulse is shorten to steepen the rising, the period for operating the power recovery circuit correspondingly decreases to decrease the power recovery efficiency and increase the power consumption, disadvantageously.

Hereinafter, the power consumption and “rising period” are described. The luminous efficiency and reactive power are considered as main items affecting the power consumption, so that the relationship between them and “rising period” is described.

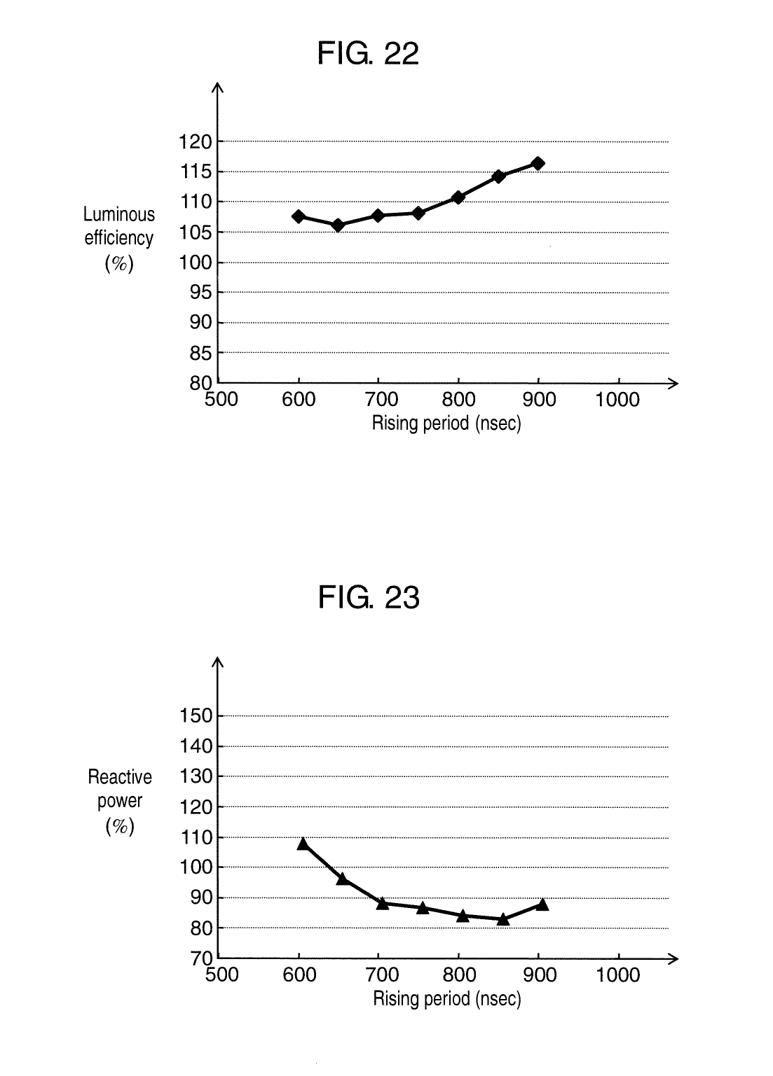

FIG. 22 is a characteristic diagram showing the relationship between “rising period” of the sustain pulse and luminous efficiency in accordance with the seventh exemplary embodiment of the present invention. In FIG. 22, the vertical axis shows the relative ratio of the luminous efficiency, and the horizontal axis shows the length of “rising period”. The unit (%) of the vertical axis is determined by assuming that a predetermined value is 100% and by deriving the ratio of the detection result of the luminous efficiency (1 m/W: emission luminance per unit power) to the predetermined value. The luminous efficiency increases as the numerical value on the vertical axis increases.

FIG. 23 is a characteristic diagram showing the relationship between “rising period” of the sustain pulses and the reactive power in accordance with the seventh exemplary embodiment of the present invention. In FIG. 23, the vertical axis shows the relative ratio of the reactive power, and the horizontal axis shows the length of “rising period”. The unit (%) of the vertical axis is determined by assuming that a predetermined value is 100% and by deriving the ratio of the detection result of the reactive power (W) to the predetermined value. The reactive power increases as the numerical value increases.

Experiments of FIG. 22 and FIG. 23 are performed while the resonance cycle of the power recovery circuit is set at 2000 nsec, the length of one cycle of the sustain pulses is set at 2.7 μsec, “decreasing period” is set at 900 nsec, and “rising period” is increased from 600 nsec to 900 nsec in steps of 50 nsec.

As is clear from FIG. 22 and FIG. 23, as the length of “rising period” is increased, the luminous efficiency is increased and the reactive power is decreased. Here, the length is the operation period of the power recovery circuit. This is because increasing “rising period” increases the ratio of the power used for causing discharge to the power recovered by the power recovery circuit.

Therefore, in order to increase the power recovery efficiency by the power recovery circuit to reduce the power consumption, the period for operating the power recovery circuit increases as long as possible. In other words, the rising is moderated by increasing “rising period” of the sustain pulses as long as possible.

In the present exemplary embodiment, the first sustain pulse is set to have “rising period” of a length enabling the following operation: the power consumption can be reduced by increasing the power recovery efficiency by the power recovery circuit in consideration of the difference in timing of causing discharge between the discharge cells.

In the present exemplary embodiment, when an image is displayed where the afterimage strength level is high and the possibility of causing the afterimage phenomenon is considered to be high, sustain pulses are generated while the generation ratio of the second sustain pulse is increased. Here, in the second sustain pulse, the difference in timing of causing discharge between the discharge cells is suppressed, and the suppressing effect of the afterimage phenomenon is high. When an image is displayed where the afterimage strength level is low and the possibility of causing the afterimage phenomenon is considered to be low, sustain pulses are generated while the generation ratio of the first sustain pulse is increased. Here, in the first sustain pulse, the effect of increasing the power recovery efficiency of the power recovery circuit and reducing the power consumption is high.

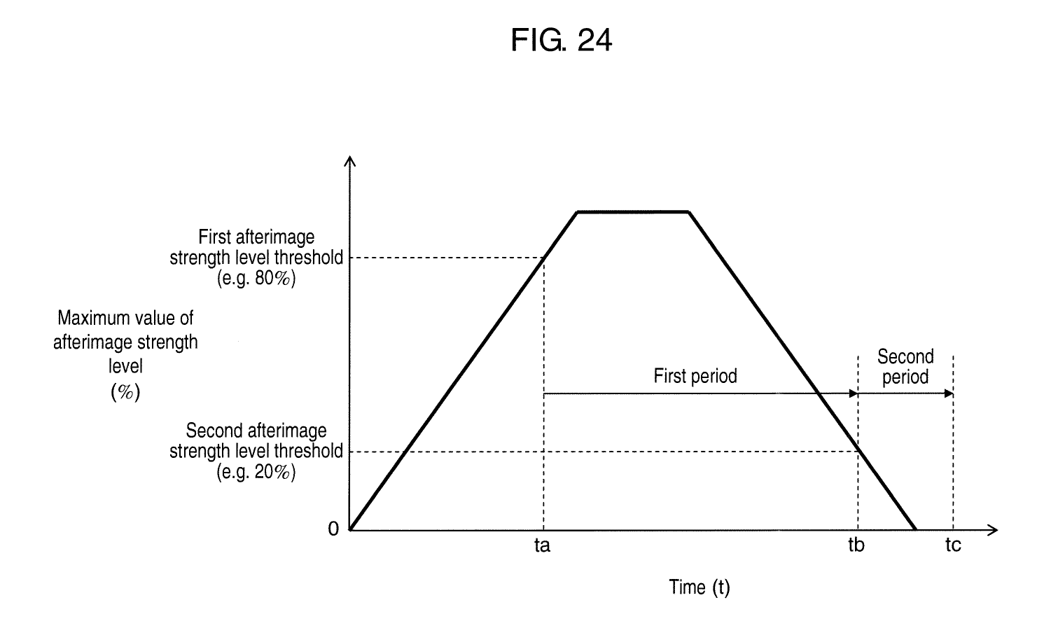

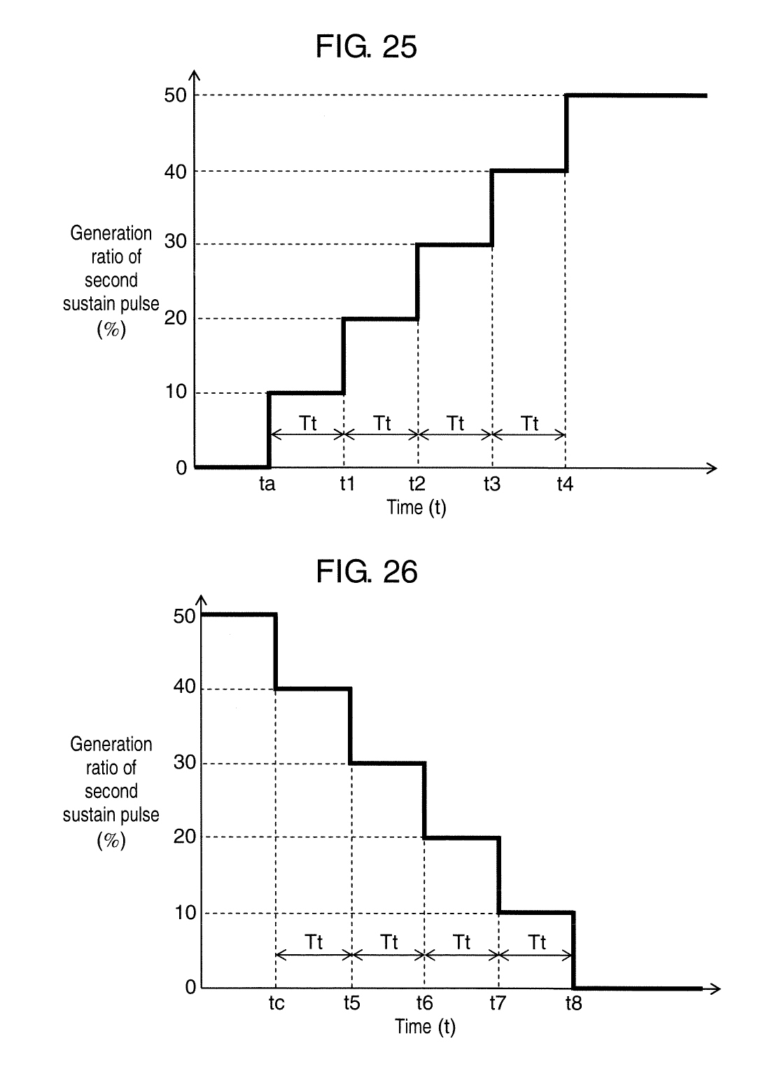

FIG. 24 is a schematic diagram showing one example of time variation in maximum value of afterimage strength level in accordance with the seventh exemplary embodiment of the present invention. FIG. 25 is a schematic diagram showing one example of change of the generation ratio of the second sustain pulse in accordance with the seventh exemplary embodiment of the present invention. FIG. 26 is a schematic diagram showing another example of change of the generation ratio of the second sustain pulse in accordance with the seventh exemplary embodiment of the present invention.

In FIG. 24, the vertical axis shows the maximum value of afterimage strength level, and the upper limit value used for restricting circuit 91 shown in FIG. 7 is assumed to be 100%. The horizontal axis shows time. In FIG. 25 and FIG. 26, the horizontal axis shows time. Time ta of FIG. 25 and time ta of FIG. 24 show the same time, and time tc of FIG. 26 and time tc of FIG. 24 show the same time. The vertical axis shows the generation ratio of the second sustain pulse. For example, 50% on the vertical axis shows that, when 10 sustain pulses are generated, five sustain pulses of them are first sustain pulses and the remaining five sustain pulses are second sustain pulses.

In the present exemplary embodiment, by setting the first afterimage strength level threshold at an appropriate numerical value (for example, corresponding to 80% of the highest one of the numerical values output from afterimage strength level calculating circuits 79), the afterimage phenomenon can be determined to be apt to occur when the maximum value of the afterimage strength level is equal to the first afterimage strength level threshold or higher.

In the present exemplary embodiment, the first afterimage strength level is set at an appropriate numerical value, and the generation ratio of the second sustain pulse having a high effect of suppressing the afterimage phenomenon is increased after the maximum value of the afterimage strength level detected by afterimage strength level maximum value detecting circuit 180 becomes the first afterimage strength level threshold or higher (after time ta of FIG. 24). Thus, when an image is displayed where the maximum value of the afterimage strength level becomes the first afterimage strength level threshold or higher and the afterimage phenomenon can be determined to be apt to occur, the occurrence of the afterimage phenomenon can be suppressed.

In this case, in the present exemplary embodiment, the generation ratio of the second sustain pulse is not increased steeply at time ta, but, after time ta, the generation ratio of the second sustain pulse is gradually increased toward the upper limit (e.g. 50%) of the generation ratio of the second sustain pulse. For example, when the generation ratio of the second sustain pulse until time ta is assumed to be 0%, the generation ratio of the second sustain pulse is gradually increased toward the upper limit at the interval of period Tt in the following manner, for example. The generation ratio of the second sustain pulse is set at 10% in the period Tt (for example, corresponding to five fields) from time ta to time t1, and is set at 20% in the period Tt from time t1 to time t2. Thus, the luminance variation caused by changing the generation ratio of the second sustain pulse can be made difficult to be recognized by a user.

In the present exemplary embodiment, since the second afterimage strength level threshold is set at an appropriate numerical value (for example, corresponding to 20% of the largest one of the numerical values output from afterimage strength level calculating circuits 79), the possibility of causing the afterimage phenomenon can be determined to decrease when the maximum value of the afterimage strength level becomes the second afterimage strength level threshold or lower.

In the present exemplary embodiment, the second afterimage strength level threshold is set at an appropriate numerical value. After the maximum value of the afterimage strength level detected by afterimage strength level maximum value detecting circuit 180 becomes the second afterimage strength level threshold or lower, the generation ratio of the second sustain pulse is decreased and the generation ratio of the first sustain pulse having an effect of reducing the power consumption is increased. Thus, when an image is displayed where the maximum value of the afterimage strength level becomes the second afterimage strength level threshold or lower and the possibility of causing the afterimage phenomenon can be determined to decrease, panel driving having a high effect of reducing the power consumption can be performed.

In this case, the generation ratio of the second sustain pulse is not decreased at time tb when the maximum value of the afterimage strength level becomes the second afterimage strength level threshold or lower, but the generation ratio of the second sustain pulse is started to be decreased at time tc after a lapse of a predetermined time after the maximum value of the afterimage strength level becomes the second afterimage strength level threshold or lower. This operation considers the following behavior: the possibility of causing the afterimage phenomenon does not decrease immediately after the maximum value of the afterimage strength level becomes the second afterimage strength level threshold or lower, and a degree of time is required before the variation of the component concentration of discharge gas that is considered as one factor of causing the afterimage phenomenon is eliminated.

In the present exemplary embodiment, “first period” is assumed to be the period after the maximum value of the afterimage strength level becomes the first afterimage strength level threshold or higher until it becomes the second afterimage strength level threshold or lower, and “second period” is assumed to be a predetermined period after the maximum value of the afterimage strength level becomes the second afterimage strength level threshold or lower until the generation ratio of the second sustain pulse is started to be decreased. Then, “second period” is changed within a range of a predetermined upper limit time (e.g. 10 minutes) or shorter in response to “first period”. For example, “second period” may be set to be ⅓ of “first period”.

In the present exemplary embodiment, similarly to FIG. 25, the generation ratio of the second sustain pulse is not decreased steeply at time tc, but, after time tc, the generation ratio of the second sustain pulse is gradually decreased toward the lower limit (e.g. 0%) of the generation ratio of the second sustain pulse. For example, when the generation ratio of the second sustain pulse until time tc is assumed to be 50%, as shown in FIG. 26, the generation ratio of the second sustain pulse is gradually decreased to the lower limit at the interval of period Tt in the following manner, for example. The generation ratio of the second sustain pulse is set at 40% in the period Tt (for example, corresponding to five fields) from time tc to time t5, and is set at 30% in the period Tt from time t5 to time t6. Thus, the luminance variation caused by changing the generation ratio of the second sustain pulse can be made difficult to be recognized by a user.

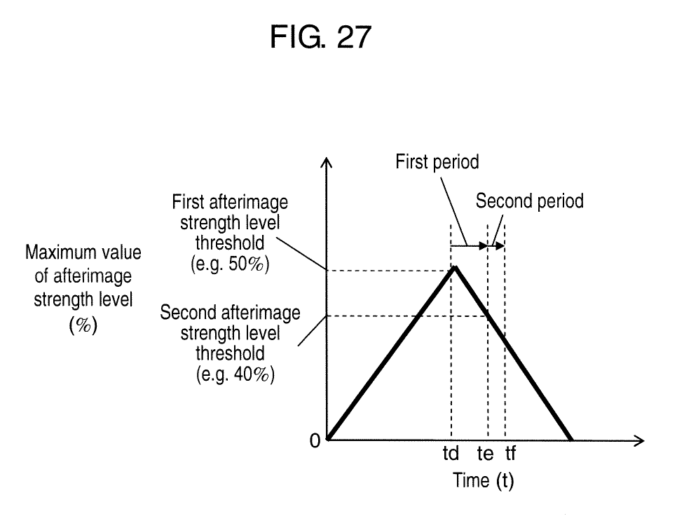

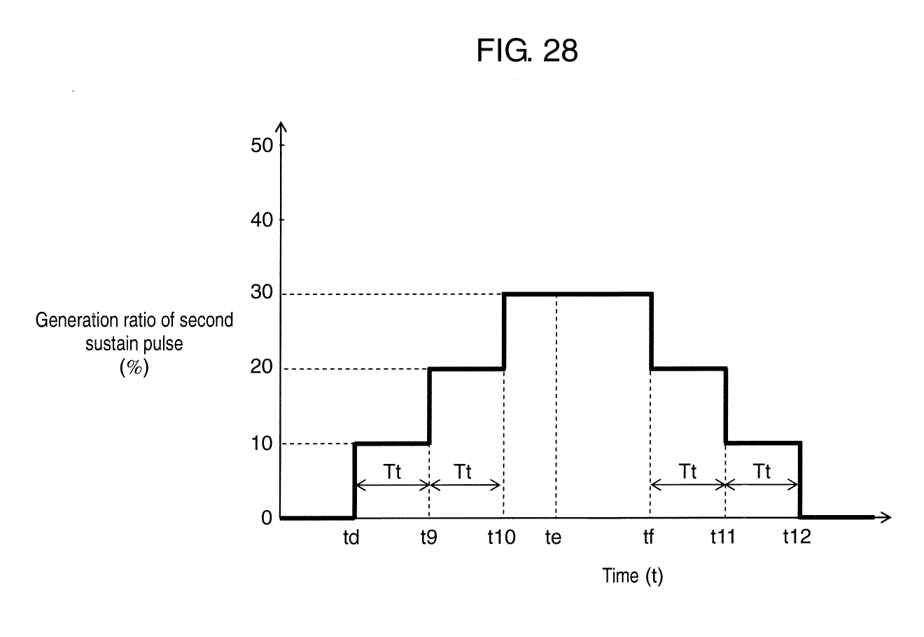

FIG. 27 is a schematic diagram showing another example of time variation in maximum value of afterimage strength level in accordance with the seventh exemplary embodiment of the present invention. FIG. 28 is a schematic diagram showing yet another example of change of the generation ratio of the second sustain pulse in accordance with the seventh exemplary embodiment of the present invention. The vertical axis and horizontal axis of FIG. 27 are similar to those of FIG. 24. The vertical axis and horizontal axis of FIG. 28 are similar to those of FIG. 25. Time td, time te, and time tf of FIG. 27 are the same as time td, time te, and time tf of FIG. 28, respectively.

For example, dependently on the set values of the first afterimage strength level threshold and second afterimage strength level threshold and on the pattern of the display image, the following phenomenon can occur. After the maximum value of the afterimage strength level becomes the first afterimage strength level threshold or higher, the maximum value of the afterimage strength level becomes the second afterimage strength level threshold or lower before the generation ratio of the second sustain pulse reaches the upper limit.

For example, as shown in FIG. 27, the maximum value of the afterimage strength level starts to decrease immediately after time td when it becomes the first afterimage strength level threshold (50% in the example of FIG. 27) or higher. The maximum value of the afterimage strength level becomes the second afterimage strength level threshold (40% in the example of FIG. 27) or lower at time te before the generation ratio of the second sustain pulse reaches its upper limit.

In such a case, as shown in FIG. 28, the generation ratio of the second sustain pulse is gradually increased as shown in FIG. 25 after time td until time te, and the generation ratio of the second sustain pulse is kept in the state of time te after time te. For example, in the example of FIG. 28, the generation ratio of the second sustain pulse is kept at 30%.

After time tf when “second period” passes from time te, the generation ratio of the second sustain pulse is gradually decreased as shown in FIG. 26.

When the maximum value of the afterimage strength level increases and becomes the first afterimage strength level threshold or higher before “second period” passes from time te, the generation ratio of the second sustain pulse is increased again from that time. This operation is not shown.

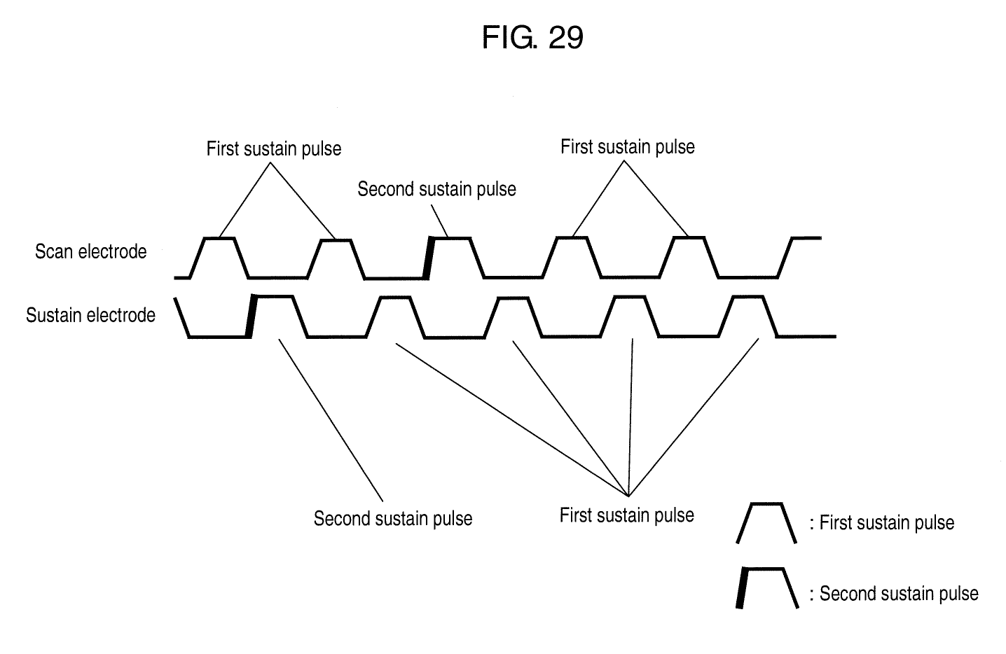

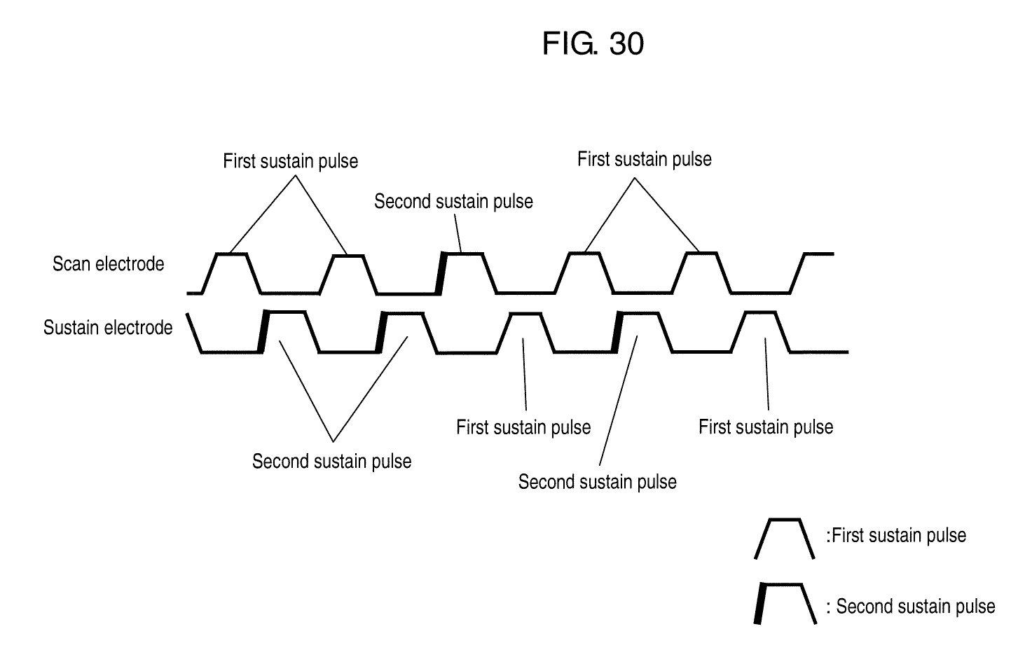

FIG. 29 is a schematic waveform chart showing one example of generation of the first sustain pulse and the second sustain pulse when the generation ratio of the second sustain pulse is 20% in accordance with the seventh exemplary embodiment of the present invention. FIG. 30 is a schematic waveform chart showing one example of generation of the first sustain pulse and the second sustain pulse when the generation ratio of the second sustain pulse is 40% in accordance with the seventh exemplary embodiment of the present invention.

In the present exemplary embodiment, the fact that the generation ratio of the second sustain pulse is 20% means the following phenomenon: when 10 sustain pulses are generated, eight sustain pulses of them are first sustain pulses and the remaining two sustain pulses are second sustain pulses as shown in FIG. 29. The fact that the generation ratio of the second sustain pulse is 40% means the following phenomenon: when 10 sustain pulses are generated, six sustain pulses of them are first sustain pulses and the remaining four sustain pulses are second sustain pulses as shown in FIG. 30.

In the present invention, the generating sequence of the first sustain pulse and second sustain pulse are not limited to the sequence shown in FIG. 29 and FIG. 30. Preferably, the generating sequence of the first sustain pulse and second sustain pulse is set optimally based on the characteristics of panel 10 and the specification of plasma display apparatus 1 and in consideration of the quality of the display image.

As discussed above, in the present exemplary embodiment, when an image is displayed where the afterimage strength level is high and the possibility of causing the afterimage phenomenon is considered to be high, sustain pulses are generated while the generation ratio of the second sustain pulse is increased. Here, in the second sustain pulse, the difference in timing of causing discharge between the discharge cells is suppressed, and the effect of suppressing the afterimage phenomenon is high. When an image is displayed where the afterimage strength level is low and the possibility of causing the afterimage phenomenon is considered to be low, sustain pulses are generated while the generation ratio of the first sustain pulse is increased. Here, the first sustain pulse has a high effect of increasing the power recovery efficiency of the power recovery circuit and reducing the power consumption. Thus, the sustain discharge can be caused stably while the power consumption is reduced in plasma display apparatus 2, and the image display quality can be improved by reducing the occurrence of the afterimage phenomenon.

Specific numerical values of the first afterimage strength level threshold and second afterimage strength level threshold, the relationship between “first period” and “second period”, and the generation ratio of the second sustain pulse are simply one example in the present embodiment. The present invention is not limited to these numerical values. Numerical values are preferably set optimally based on the characteristics of panel 10 and the specification of plasma display apparatus 1 and in consideration of the quality of the display image.

In the seventh exemplary embodiment, subtracting circuit 74 subtracts the luminance gradation value set for each pixel from the luminance gradation value of the immediately preceding pixels output from one-pixel delay circuit 73, and calculates the luminance-difference-between-adjacent-pixels between two pixels (horizontally adjacent pixels) adjacent in the extending direction of display electrode pairs 24. However, the present invention is not limited to this configuration. For example, the following configuration may be employed: subtracting circuit 74 subtracts the luminance gradation value set for each pixel from the luminance gradation value preceding by one horizontal period, and calculates the luminance-difference-between-adjacent-pixels between two pixels (vertically adjacent pixels) adjacent in the extending direction of data electrodes 32. Alternatively, the following configuration may be employed: subtracting circuit 74 subtracts the luminance gradation value set for each pixel from the luminance gradation value preceding by (one horizontal period+one pixel), subtracts the luminance gradation value set for each pixel from the luminance gradation value preceding by (one horizontal period−one pixel), and calculates the luminance-difference-between-adjacent-pixels between two pixels adjacent diagonally on panel 10. Alternatively, subtracting circuit 74 may use the maximum value among the luminance-difference-between-adjacent-pixels calculated between horizontally adjacent pixels, the luminance-difference-between-adjacent-pixels calculated between vertically adjacent pixels, and the luminance-difference-between-adjacent-pixels calculated between diagonally adjacent pixels.

In the present exemplary embodiment, “second period” is changed in response to “first period”. However, “second period” may be a predetermined period (e.g. 5 minutes). Alternatively, a configuration may be employed where “second period” is set at 0 and the generation ratio of the second sustain pulse is gradually decreased immediately after the maximum value of the afterimage strength level becomes the second afterimage strength level threshold or lower.

### Eighth Exemplary Embodiment

In the seventh exemplary embodiment, the configuration where the generation ratio of the second sustain pulse is changed based on the maximum value of the afterimage strength level has been described. However, the configuration may be employed where the generation ratio of the second sustain pulse is changed based on the average value of the afterimage strength level.

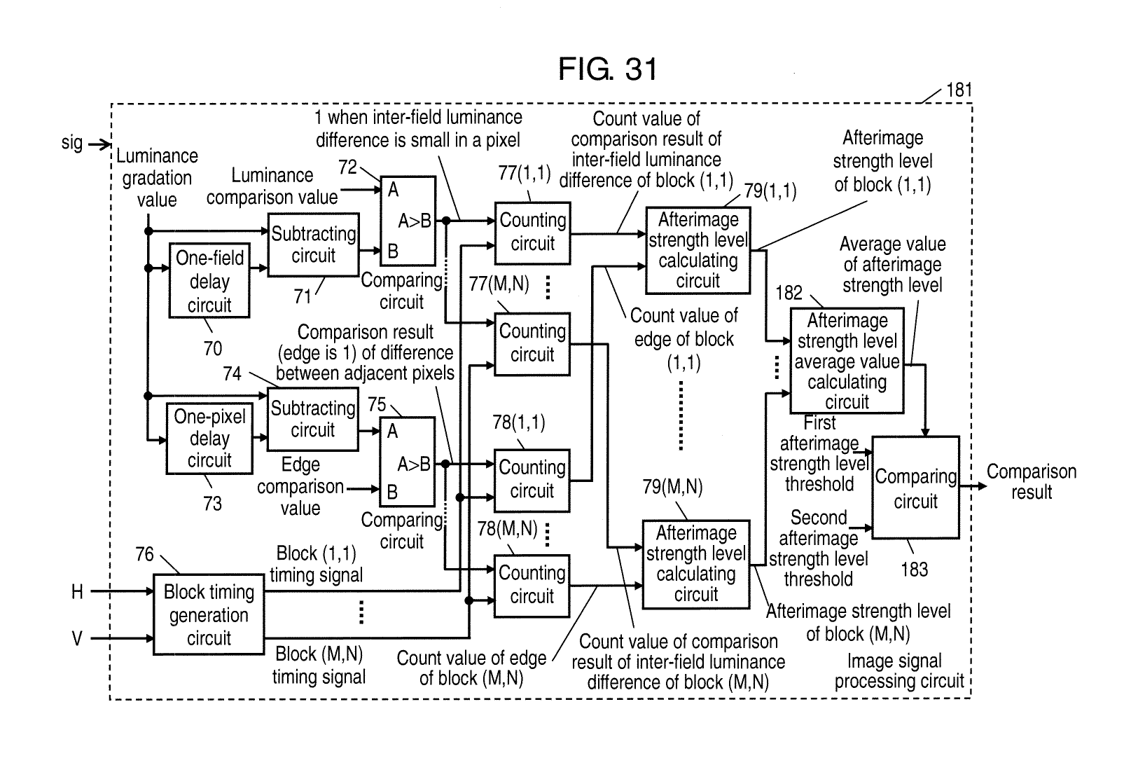

FIG. 31 is a circuit block diagram showing one configuration example of image signal processing circuit 181 in accordance with an eighth exemplary embodiment of the present invention. FIG. 31 shows only a circuit block for calculating afterimage strength level, and the other circuit blocks are omitted. A procedure of calculating the afterimage strength level of each region in the present exemplary embodiment is similar to that of the seventh exemplary embodiment.

Image signal processing circuit 181 has a configuration substantially similar to that of image signal processing circuit 141 shown in FIG. 16 in the seventh exemplary embodiment, but includes afterimage strength level average value calculating circuit 182 instead of afterimage strength level maximum value detecting circuit 180.

Afterimage strength level average value calculating circuit 182 calculates the average value of M×N afterimage frequencies output from afterimage strength level calculating circuit 79 (1,1) through afterimage strength level calculating circuit 79 (M,N).

Comparing circuit 183 compares the average value of M×N afterimage frequencies calculated by afterimage strength level average value calculating circuit 180 with a predetermined first afterimage strength level threshold and a second afterimage strength level threshold, which is lower than the first afterimage strength level threshold, and outputs the comparison result to timing generation circuit 145.

Timing generation circuit 145 changes the generation ratio of the second sustain pulse in response to the comparison result by comparing circuit 183.

Even such a configuration can provide an effect similar to that of the seventh exemplary embodiment.

Each circuit block shown in the exemplary embodiments of the present invention may be configured as an electric circuit for performing each operation shown in the exemplary embodiments, or may be configured using a microcomputer or the like programmed so as to perform a similar operation.

The configurations of the first exemplary embodiment through the eighth exemplary embodiment of the present invention may be combined.

In the exemplary embodiments of the present invention, a configuration for changing the luminance comparison value and edge comparison value is not especially described. However, one or both of the luminance comparison value and edge comparison value may be changed in response to the place of panel 10. A typical example of a pattern displayed in a static state for a certain time is characters by subtitles or the present time, but they are generally displayed in a peripheral part in panel 10. Therefore, the following configuration may be employed: the set values of the luminance comparison value and edge comparison value are smaller in the peripheral part in panel 10 than in the center part thereof, and the afterimage strength level is apt to be higher in the peripheral part in panel 10 than in the center part thereof.

The driving voltage waveforms shown in FIG. 3 are simply one example in the exemplary embodiments. The present invention is not limited to these driving voltage waveforms.

The exemplary embodiments of the present invention can be applied to a driving method of a panel by the so-called two-phase drive, and can provide an effect similar to the above-mentioned one. The two-phase drive means a driving method of the following steps:
dividing scan electrode SC1 through scan electrode SCn into a first scan electrode group and a second scan electrode group; and
forming the address period using a first address period for applying a scan pulse to each of the scan electrodes belonging to the first scan electrode group and a second address period for applying a scan pulse to each of the scan electrodes belonging to the second scan electrode group.

The exemplary embodiments of the present invention are also useful for a panel having an electrode structure where a scan electrode is adjacent to another scan electrode and a sustain electrode is adjacent to another sustain electrode, namely the array of the electrodes disposed on front plate 21 is “ . . . , scan electrode, scan electrode, sustain electrode, sustain electrode, scan electrode, scan electrode, . . . ”

Each specific numerical value shown in the exemplary embodiments of the present invention is set based on the characteristics of panel 10 having a screen size of 50 inches and having 1080 display electrode pairs 24, and is simply one example in the embodiment. The present invention is not limited to these numerical values. Numerical values are preferably set optimally in response to the characteristics of the panel or the specification of the plasma display apparatus. The number of subfields and luminance weight of each subfield are not limited to the values shown in the exemplary embodiments of the present invention, but the subfield structure may be changed based on an image signal or the like. These numerical values can vary in a range allowing the above-mentioned effect.

### INDUSTRIAL APPLICABILITY

The present invention can achieve high image display quality by reducing the afterimage phenomenon of a display image on a panel. Therefore, the present invention is useful as a driving method of the panel and a plasma display apparatus.

### REFERENCE MARKS IN THE DRAWINGS

1, 2 plasma display apparatus
10 panel
21 (glass-made) front plate
22 scan electrode
23 sustain electrode
24 display electrode pair
25, 33 dielectric layer
26 protective layer
31 rear plate
32 data electrode
34 barrier rib
35 phosphor layer
41, 141, 181 image signal processing circuit
42 data electrode driver circuit
43 scan electrode driver circuit
44 sustain electrode driver circuit
45, 145 timing generation circuit
50, 60 sustain pulse generation circuit
51, 61 power recovery circuit
52, 62 clamping circuit
63, 64, 65, 72, 95, 183 comparing circuit
66, 67, 68 selector
70 one-field delay circuit
71, 74, 90 subtracting circuit
73 one-pixel delay circuit
76 block timing generation circuit
77, 78 counting circuit
79 afterimage strength level calculating circuit
80 afterimage strength level interpolating circuit
81 delay circuit
82, 83, 84, 85, 86, 87 correcting circuit
89 cumulative adding circuit
91 restricting circuit
92, 94, 99 multiplication coefficient calculating circuit
93, 100 multiplying circuit
96, 101 afterimage strength level correcting circuit
97 APL detecting circuit
98 smoothing circuit
180 afterimage strength level maximum value detecting circuit
182 afterimage strength level average value calculating circuit
Q11, Q12, Q13, Q14, Q21, Q22, Q23, Q24, Q26, Q27, Q28, Q29 switching element
C10, C20, C30 capacitor
L10, L20 inductor
D11, D12, D21, D22, D30 diode

1. A driving method of a plasma display panel including:
dividing an image display region of the plasma display panel into a plurality of regions;
calculating, as inter-field luminance difference, a difference between a luminance gradation value in a present field and a luminance gradation value in a field immediately before the present field for each pixel, counting a number of pixels where the inter-field luminance difference is smaller than a predetermined luminance comparison value for each region, and setting a counting result of counting the number of pixels as a first count value in each region;
counting, for each region, a number of edges where difference between luminance gradation values of adjacent pixels is equal to a predetermined edge comparison value or larger, and setting the counting result as a second count value in each region; and
calculating afterimage strength level of each region based on the first count value and the second count value.

2. The driving method of the plasma display panel of claim 1, wherein the afterimage strength level of each region is updated by:
adding a first set value to the afterimage strength level of each region in regions where the first count value is equal to a first threshold or larger and the second count value is equal to a third threshold or larger;
adding a second set value to the afterimage strength level of each region in regions where the first count value is smaller than the first threshold and is not smaller than a second threshold that is smaller than the first threshold and the second count value is equal to the third threshold or larger;
adding a third set value to the afterimage strength level of each region in regions where the first count value is smaller than the second threshold and the second count value is equal to the third threshold or larger; and
adding a fourth set value to the afterimage strength level of each region in regions where the second count value is smaller than the third threshold.

3. The driving method of the plasma display panel of claim 2, wherein
the first set value is a positive numerical value, the second set value is 0, and the third set value and fourth set value are negative numerical values.

4. The driving method of the plasma display panel of claim 2, further comprising
subtracting a predetermined constant from the afterimage strength level after the update.

5. The driving method of the plasma display panel of claim 2, further comprising subtracting
restricting the afterimage strength level after the update not to exceed a predetermined upper limit.

6. The driving method of the plasma display panel of claim 1, further comprising:
setting the afterimage strength level of each region as afterimage strength level of a center pixel positioned in the center of each region;
calculating afterimage strength level of each of pixels other than the center pixel based on the afterimage strength level of the center pixel and distances between the pixel whose afterimage strength level is to be calculated and a plurality of center pixels around the pixel; and
changing the luminance gradation value of each pixel based on the afterimage strength level of each pixel.

7. The driving method of the plasma display panel of claim 6, further comprising:
changing the luminance gradation value of each pixel by subtracting the afterimage strength level of each pixel from a predetermined reference value and by multiplying the luminance gradation value of each pixel by a result obtained by dividing the subtraction result by the reference value.

8. The driving method of the plasma display panel of claim 6, further comprising:
changing the luminance gradation value based on afterimage strength level only in a pixel where the luminance gradation value of each pixel is equal to a predetermined high-luminance threshold or higher.

9. The driving method of the plasma display panel of claim 6, further comprising:
detecting an average picture level of an image signal; and
changing the afterimage strength level of each pixel based on the average picture level so that the afterimage strength level is low when the average picture level is high than when the average picture level is low.

10. The driving method of the plasma display panel of claim 6, further comprising:
changing the afterimage strength level of each pixel based on a luminance magnification so that the afterimage strength level is lower when the luminance magnification is low than when the luminance magnification is high.

11. The driving method of the plasma display panel of claim 6, further comprising:
smoothing the luminance gradation value of each pixel based on the afterimage strength level of each pixel so that the luminance gradation value is smoother when the afterimage strength level is high than when the afterimage strength level is low.

12. The driving method of the plasma display panel of claim 6, further comprising:
changing, based on the afterimage strength level of each pixel, chroma set for each pixel based on an image signal; and
making the chroma lower when the afterimage strength level is high than when the afterimage strength level is low.

13. The driving method of the plasma display panel of claim 1, further comprising:
setting the regions by disposing a plurality of boundaries in an extension direction of the display electrode pairs and a plurality of boundaries in an extension direction of the data electrodes so that number of pixels of each region can be equal to each other.

14. The driving method of the plasma display panel of claim 1, further comprising:
generating a first sustain pulse and a second sustain pulse in the sustain period, the second sustain pulse rising more steeply than the first sustain pulse; and
changing a generation ratio between the first sustain pulse and the second sustain pulse based on the afterimage strength level.

15. The driving method of the plasma display panel of claim 14, further comprising:
detecting a maximum value of the afterimage strength level of each region;
gradually increasing the generation ratio of the second sustain pulse after a maximum value of the afterimage strength level becomes a first afterimage strength level threshold or higher; and
gradually decreasing the generation ratio of the second sustain pulse after a lapse of a predetermined period after the maximum value of the afterimage strength level becomes a second afterimage strength level threshold or lower, the second afterimage strength level threshold being lower than the first afterimage strength level threshold.

16. The driving method of the plasma display panel of claim 15, further comprising:
assuming, as a first period, a period after the maximum value of the afterimage strength level becomes the first afterimage strength level threshold or higher until the maximum value becomes the second afterimage strength level threshold or lower;
assuming the predetermined period as a second period; and
changing the second period according to the first period within a range of a predetermined upper limit period or shorter.

17. The driving method of the plasma display panel of claim 16, where in
the second period is set to be one-third of the first period.

18. The driving method of the plasma display panel of claim 14, the driving method comprising:
calculating an average value of the afterimage strength level in each region;
gradually increasing the generation ratio of the second sustain pulse after the average value of the afterimage strength level becomes a first afterimage strength level threshold or higher; and
gradually decreasing the generation ratio of the second sustain pulse after a lapse of a predetermined period after the average value of the afterimage strength level becomes a second afterimage strength level threshold or lower, the second afterimage strength level threshold being lower than the first afterimage strength level threshold.

19. (canceled)

20. A plasma display apparatus comprising:
a plasma display panel that has a plurality of discharge cells each of which has a display electrode pair including a scan electrode and a sustain electrode and performs gradation display by using a structure of a pixel including a plurality of discharge cells, one field including a plurality of subfields each of which has an address period and a sustain period; and
an image signal processing circuit for setting a luminance gradation value for each pixel based on an image signal and for generating image data indicating light emission and no light emission in each subfield in the discharge cells based on the image signal,
wherein the image signal processing circuit is configured to;
divide an image display region of the plasma display panel into a plurality of regions,
calculate an afterimage strength level of each region based on the luminance gradation value set for each pixel in response to the image signal,
calculate an afterimage strength level of each pixel based on the afterimage strength level of each region, and
change the luminance gradation value of each pixel based on the afterimage strength level of each pixel.

21. A plasma display apparatus comprising:
a plasma display panel including a plurality of discharge cells each of which has a display electrode pair including a scan electrode and a sustain electrode, the plasma display panel being configured to perform gradation display by using a structure of a pixel including a plurality of discharge cells, one field including a plurality of subfields each of which has an address period and a sustain period;
an image signal processing circuit for setting a luminance gradation value for each pixel based on an image signal and for generating image data indicating light emission and no light emission in each subfield in the discharge cells based on the image signal; and
a sustain pulse generation circuit including a power recovery circuit for raising or decreasing a sustain pulse by resonating an inductor and an inter-electrode capacity of the display electrode pairs, and a clamping circuit for clamping voltage of the sustain pulse on a predetermined voltage, the sustain pulse generation circuit alternately applying, to the display electrode pairs, sustain pulses in a quantity corresponding to a luminance weight set for each subfield in the sustain period,
wherein the image signal processing circuit divides an image display region of the plasma display panel into a plurality of regions, and calculates afterimage strength level of each region based on the luminance gradation value set for each pixel in response to the image signal, and
wherein the sustain pulse generation circuit generates a first sustain pulse and a second sustain pulse rising more steeply than the first sustain pulse, and changes a generation ratio between the first sustain pulse and the second sustain pulse based on the afterimage strength level.

22. The plasma display apparatus of claim 21, wherein
the image signal processing circuit includes:
an afterimage strength level maximum value detecting circuit for detecting a maximum value of the afterimage strength level of each region; and
a comparing circuit for comparing the maximum value of the afterimage strength level with a first afterimage strength level threshold and with a second afterimage strength level threshold, the second afterimage strength level threshold being lower than the first afterimage strength level threshold, and
the sustain pulse generation circuit gradually increases the generation ratio of the second sustain pulse after the maximum value of the afterimage strength level becomes the first afterimage strength level threshold or higher, and gradually decreases the generation ratio of the second sustain pulse after a lapse of a predetermined period after the maximum value of the afterimage strength level becomes the second afterimage strength level threshold or lower.

23. The plasma display apparatus of claim 21, wherein
the image signal processing circuit includes:
an afterimage strength level average value calculating circuit for calculating an average value of the afterimage strength level of each region; and
a comparing circuit for comparing the average value of the afterimage strength level with a first afterimage strength level threshold and with a second afterimage strength level threshold, the second afterimage strength level threshold being lower than the first afterimage strength level threshold, and
the sustain pulse generation circuit gradually increases the generation ratio of the second sustain pulse after the average value of the afterimage strength level becomes the first afterimage strength level threshold or higher, and gradually decreases the generation ratio of the second sustain pulse after a lapse of a predetermined period after the average value of the afterimage strength level becomes the second afterimage strength level threshold or lower.
